(19) United States
(12) Patent Application Publication
(10) Pub. No.: US 2008/0072469 A1
(43) Pub. Date: Mar. 27, 2008

(54) Apparatus and method for binding thick sheets including photographs

(76) Inventors: Kevin P. Parker, Berkeley, CA (US); Wayne Kasom, Oakland, CA (US); Harold P. Hocking, Manhattan Beach, CA (US); Nicholas G. Paget, San Francisco, CA (US)

Correspondence Address: Philip A. Girard;GIRARD & EQUITZ LLP, Suite 1110, 400 Montgomery Street, San Francisco, CA, 94104, US

(21) Appl. No.: 11/528,716

(22) Filed: Sep. 27, 2006

(51) Int. Cl. B42C 13/00; B42C 9/00; G09F 19/00

(52) U.S. Cl. 40/537; 412/10; 412/33; 412/37; 412/8

(57) ABSTRACT

A bound book for displaying photographs and the like including a carrier sheet arrangement folded at least once to provide two carrier sheets separated by a fold and having respective dimensions similar a pair of display sheets, such as photographs, to be displayed. The display sheets are mounted on the respective carrier sheets by respective fastening layers. In one embodiment, the fastening layers include pressure sensitive adhesive and an associated support structure to prevent the pressure sensitive adhesive for adhering during assembly of the book when the display sheets are initially positioned over the fastening layers. The carrier sheet arrangement, display sheets and fastening layers are positioned within a cover assembly, with pressure then being applied to the cover assembly so as to activate the pressure sensitive adhesive and thereby secure the respective display sheets to the respective carrier sheets.

### BACKGROUND OF THE INVENTION

1. Field of the Invention

The present invention relates generally to binding apparatus and, in particular, to binding apparatus and methods for binding thick sheets such as photographs.

2. Related Art

Photograph albums are becoming more popular, particularly with the advent of digital photography. One conventional approach is to secure the individual photographs in a pre-bound album having individual sheets to which the photographs are attached using adhesives and the like. The advantage of this approach is reduced costs at the expense of appearance. It is also possible to produce a photo album using commercial binding techniques to provide a more attractive product, but at a very substantial cost.

A typical commercially bound photo album, without the hardcover, is depicted in FIGS. 1A-1C of the drawings. An exemplary photograph 20 to be bound is shown in FIG. 1A for producing the bound album. The photograph 20 includes a central score line 22 to facilitate folding the photograph. Thus, for an album that is approximately 4×5 inches, the photograph 20 should be 8×5 inches. Multiple images can be placed on the photograph using photo editing techniques, taking into account that the photograph will be folded in the center. Images are printed only on one side of the photograph 20. The album shown in FIGS. 1B and 1C includes a total of three folded photographs 20A, 20B and 20C to provide a total of four album pages. One half of photograph 20A forms one page, with the other half of photograph 20A and half of photograph 20B forming a second page. The remaining third and fourth pages of the album are formed from the second half of photograph 20B and photograph 20C. The photographs 20A, 20B and 20C are each folded so that the images of each photograph face one another. The three photographs are secured to one another by way of two layers of adhesive 26 which attach the non-image side of the photographs together.

The three photographs are bound together, as represented by symbol 24, using conventional commercial binding techniques. Typically, the pages are bound together using an adhesive, with a reinforcing cloth present to add strength. These techniques are suitable for accommodating photographs which, as compared to sheets of paper, are relatively thick and rigid, particularly at the regions where the photographs are adhered together. The final album, with added hardcover, is attractive but very expensive and is thus usually reserved for wedding albums and albums for other special occasions.

Another conventional binding approach is illustrated schematically in FIG. 2 where four individual photographs 28A, 28B, 28C and 28D are bound together using a conventional binder strip applied using a conventional desk-top binding machine. As explained in detail in U.S. Pat. No. 5,052,873, a stack of sheets of paper can be bound using a binder strip that includes a layer of heat activated adhesive. The stack is inserted into the binding machine, with the machine functioning to apply the binder strip to the stack edge and to apply heat so as to activate the adhesive. Once the adhesive has cooled, a hardcover can then be applied to the bound stack. The same approach can be used to bind photographs, with numeral 30 representing the binder strip adhesive. This approach provides an attractive photo album at a very low price compared to the previously described commercial binding techniques. However, since each page includes only one photograph having an image on one side only, the back of each photograph can be observed by a viewer. This is a disadvantage in some applications, particularly when photo paper information or the like is printed on the backside of the photo. It would be possible to glue the back of two photographs together to provide one album page for each of the two photographs. However, because each page includes two photographs, the pages would be relatively thick and rigid. Such pages are not ideal for binding using the binder strip.

Epson American Inc. markets a product under the name “Story Teller Photo Book Creator” which is schematically depicted in FIG. 3. The product includes a bound stack of plain sheets which are bound together using conventional binding techniques represented by adhesive 30. Only a single complete bound plain sheet is depicted, with that bound sheet including a binding section 38A and a detachable section 40 separated from the binding section by perforations 42. The remaining bound sheets include bound sections 44B, 44C and 44D, with the associated detachable sections being previously removed by the end user. The plain sheet formed by binding section 38A and detachable sheet 40 has the same approximate dimensions as the photographs so that, among other things, the plain sheets 38/40 can be used to align the photographs with respect to the associated binding sections. Also depicted are fly leaves 34A and 34B which are also bound together with the sheets. The bound combination is provided with a hardcover which includes front and back cover sections 36A and 36B connected together by an intermediate spine section 36C. Each binding section 38A, 38B, 38C and 38D has an associated strip of pressure sensitive adhesive, including respective adhesive strips 44A, 44B, 44C and 44D. Each strip of pressure sensitive adhesive was originally covered by a release liner, with the liners having been previously removed during the assembly process.

The end user secures an individual photograph to each of the bound sheets by first positioning the photograph, photograph 46A for example, over one of the complete bound sheets which would include, for example, binding section 38A and attached detachable section 40. Once the photograph is aligned, the associated release liner is removed, with the user maintaining the photograph in proper alignment, thereby exposing the underlying pressure sensitive adhesive, such as adhesive 44A. The user then presses the photograph, such as photograph 46A, against the adhesive thereby securing the photograph to the binding section 38A. The user can then, if desired, remove the associated detachable sections, such as section 40. A significant disadvantage of this approach is that, as is the case of the FIG. 2 prior art embodiment, the back sides of the photographs are exposed to the viewer.

A still further prior art approach is shown in FIGS. 4A, 4B, 4C and 4D. This approach is marketed by ZoomAlbum, LLC under the name ZoomAlbum. As described at www.ZoomAlbum.com the user purchases photographic album paper which includes several individual sheets arranged in a single larger sheet. The larger sheet of photographic paper also includes various layers of pressure sensitive adhesive (not depicted in FIGS. 4A and 4B) which are presumably covered by separate release liners. Using software provided by the manufacturer, the user inserts the larger sheet of photographic paper in an ink jet printer, with the software allowing the user to locate individual images on the individual sheets of the larger sheet. Once the images are printed, the user reconfigures the large sheet, presumably using suitably located perforations and/or score lines, to arrive at a final assembly 48 as depicted in FIGS. 4A and 4B. The exemplary assembly 48 includes individual images 54A-54L applied by the printer. The images are separated by what appears to be folding cuts 50A-50E which permit the assembly to be folded at the cuts so as to provide a clean outer edge for each page of the album. The images are also separated by scribe lines or the like 52A-52F which also permit the assembly to be folded, with the scribe lines 52A-52F functioning as hinges when a user views the individual pages.

As previously noted, the assembly 48 includes various layers of pressure sensitive adhesive presumably covered with some form of release liner so that the adhesive can be exposed when required. As can be seen in FIG. 4C, pressure sensitive adhesive layers 56A-56L function to secure the back side of the image sheets together, with FIG. 4C illustrating the adhesive layers before they are forced together. By way of example, layers 56B and 56C secure the rear of the sheets carrying images 54B and 54C together so that the two image sheets form a single album page, with an image on both sides. When the ten image sheets are secured together in this manner, a total of five album pages 54B/C, 54D/E, 54F/G, 54H/I and 54J/K are produced as indicated schematically in FIG. 4D for the depicted exemplary embodiment in an open position. As also shown schematically in FIG. 4D, the folded edges 52A-52F come together to form a relatively continuous spine edge 58 which extends between front and rear cover sections 36A and 36B.

One shortcoming of the prior art approach of FIGS. 4A-4D is that specialized photographic paper having precut sections and pressure sensitive adhesives must be used. Further, it appears that size of the individual photographic images is limited since all of the images for a single book have to be printed on a single sheet.

There is a need for a relatively low cost approach for binding photographs and the like using desk-top equipment that produces an attractive bound volume having an appearance that approaches that of a commercially bound album. Such an approach would preferably not require the use of special photo-paper. As will become apparent from one skilled in the art upon a reading of the following Detailed Description of the Invention together with the drawings, the disclosed invention addresses the above-noted shortcomings of the prior art in addition to providing further advantages.

### SUMMARY OF THE INVENTION

A bound book especially adapted for displaying photographs and the like is disclosed along with other embodiments and methods. The book includes first and second display sheets, such as photographs, which are positioned within a carrier sheet arrangement. The carrier sheet arrangement is folded at least once to provide first and second carrier sheets separated by a fold, with each of the carrier sheets having dimensions similar to that of the first and second display sheets. A first fastening layer is provided which is disposed intermediate the first carrier sheet and the first display sheet, with the first fastening layer securing the first display sheet to the first carrier sheet. Similarly, a second fastening layer is provided disposed intermediate the second carrier sheet and the second display sheet, with the second fastening layer securing the second display sheet to the second carrier sheet. Both the first and second display sheets are secured so that a first edge of each sheet is disposed adjacent the first fold.

The book further includes a cover assembly including first and second covers, with the first and second display sheets being disposed intermediate the first and second covers, with the display sheets further being positioned such that the display sheets contact each other when the book is closed.

In one embodiment of the present invention, the first and second fastening layers include heat activated adhesive. The fastening layers are thus activated by applying heat to the photographs and carrier sheet arrangement combination. Moderate pressure is also applied to insure a secure bond. In a further embodiment, the first and second fastening layers on the carrier sheet arrangement include pressure sensitive adhesive and an associated support structure to prevent the pressure sensitive adhesive from adhering during assembly of the book when the display sheets are initially positioned over the fastening layers. Once the display sheets have been positioned on the carrier sheet arrangement, a substantial compression force is applied, preferably using a desk-top press, so as to displace the support structure of each fastening layer so that the adhesive in the fastening layer is available to secure the display sheet. Once the display sheets have been secured, or during such securing, the carrier sheet arrangement is installed in a hardcover assembly.

### BRIEF DESCRIPTION OF THE DRAWINGS

FIG. 1A is a prior art photograph adapted to be bound in an album.

FIGS. 1B is an end view of a prior art album using the photographs of FIG. 1A.

FIG. 1C is a perspective view of the prior art album of FIG. 1B.

FIG. 2 is a perspective view of another prior art approach to binding photographs, showing only the bound spine region.

FIG. 3 is a still further prior art approach to binding photographs where a pre-bound book is provided to which photographs are added.

FIGS. 4A and 4B show a prior art assembly of photograph paper in a fanfold arrangement.

FIG. 4C shows a prior art bound photograph album utilizing the fanfold arrangement of FIGS. 4A and 4B.

FIG. 4D is a schematic view of showing the bound spine edge of the prior art album of FIG. 4C.

FIGS. 5A is a top view of a carrier assembly in accordance with one embodiment of the present invention showing the assembly prior to folding.

FIG. 5B is a side view of the carrier assembly of FIG. 5A after folding.

FIG. 6A is a side view of a carrier assembly in accordance with one embodiment of the present invention showing photographs positioned on a carrier assembly similar to that of FIGS. 5A and 5B prior to activation of the fastening layers that secure, among other things, the photographs to the carrier assembly.

FIG. 6B is a schematic view of the loaded carrier assembly of FIG. 6A and FIG. 6C is an enlarged partial view of FIG. 6B showing details of the loaded carrier assembly in a slightly compressed position showing the relative locations of the carrier sheets, fastening layers and photographs.

FIG. 7 is a perspective view of a user positioning photographs in a carrier assembly similar to that shown in FIGS. 5A and 5B.

FIG. 8A shows a loaded carrier assembly of FIGS. 6A, 6B and 6C utilizing pressure sensitive adhesive based fastening layers positioned on the bottom plate of a press prior to compression.

FIG. 8B shows the loaded carrier assembly of FIG. 8A during compression by the press, with such compression functioning to activate the fastening layers.

FIG. 9 is a schematic end view showing details of the spine region of an album bound in accordance with one embodiment of the present invention, with the album being disposed in a hardcover assembly.

FIGS. 10A, 10B and 10C show one embodiment of a pressure sensitive adhesive based fastening layer.

FIGS. 11A, 11B and 11C show another embodiment of a pressure sensitive adhesive based fastening layer.

FIGS. 12A, 12B and 12C show a further embodiment of a pressure sensitive adhesive based fastening layer.

FIGS. 13A, 13B, 13C and 13D show a still further embodiment of a pressure sensitive adhesive based fastening layer.

FIGS. 14A, 14B and 14C show another embodiment of a pressure sensitive adhesive based fastening layer.

FIGS. 15A, 15B and 15C show an additional embodiment of a pressure sensitive adhesive based fastening layer.

FIG. 16 is a graph depicted the relationship between adhesion strength and applied force for an exemplary pressure sensitive adhesive fastening layer of the present invention and a corresponding relationship for a conventional pressure sensitive adhesive.

FIG. 17A shows a loaded carrier assembly utilizing a heat activated fastening layer in accordance with one embodiment of the present invention, with the loaded carrier positioned on the bottom plate of a heated press prior to activation.

FIG. 17B shows the loaded carrier assembly of FIG. 17A being activated by the heated press as the press applies heat to the assembly along with pressure.

FIG. 18 is a side partial view of a loaded carrier assembly as in FIG. 17A, with the bottom plate of the heated press including sidewalls for supporting the carrier assembly and with a thin electrical heating element disposed in the center of the assembly to provide supplemental heat to the assembly.

FIG. 19A is a perspective view of the lower press base showing a loaded carrier positioned on the base of the heated press with a contact of the thin heating element extending through a cut-out formed in a sidewall of the base, with FIGS. 19B and 19C schematically illustrating the tilt angle of the lower press base relative to a level plane.

FIG. 20 is another embodiment photo-album showing the carrier assembly secured to a hardcover assembly using pressure sensitive adhesive located on the assembly.

FIG. 21 is a hardcover assembly which utilizes a pair of pressure sensitive adhesive based fastening layers for securing the hardcover assembly to the carrier assembly at the same time the carrier assembly and photographs are bound.

FIG. 22 is another embodiment photo-album showing the carrier assembly secured to a hardcover assembly using pressure sensitive adhesive located on the assembly, with the front cover section including a window for viewing a portion of a photograph mounted on the inner surface of the front cover section.

FIGS. 23A, 23B, 23C and 23D shows a pair of pressure activated based fastening layer incorporating fibers such as flock, with the fibers arranged on opposing fastening layers to reduce adhesion between the fastening layers.

FIGS. 24A, 24B and 24C show on embodiment of a two carrier sheet carrier arrangement having four fastening layers.

FIGS. 25A, 25B and 25C show on embodiment of a two carrier sheet carrier sheet arrangement having three fastening layers.

FIGS. 26A, 26B and 26C show on embodiment of a two carrier sheet carrier sheet arrangement also having three fastening layers, with one the layer location differing from that of FIGS. 25A, 25B and 25C.

FIGS. 27A, 27B and 27C show on embodiment of a two carrier sheet carrier sheet arrangement having two fastening layers.

FIGS. 28A, 28B and 28C show on embodiment of a two carrier sheet carrier sheet arrangement having one fastening layer.

FIGS. 29A, 29B and 29C show the various embodiments of a two carrier sheet carrier sheet arrangement with photographs positioned on the inner fastening layers.

FIG. 30 is an photograph album formed from the various two carrier sheet carrier sheet arrangements of FIGS. 29A, 29B, 29C, 29D and 29E illustrating an exemplary application for the carrier sheet arrangements.

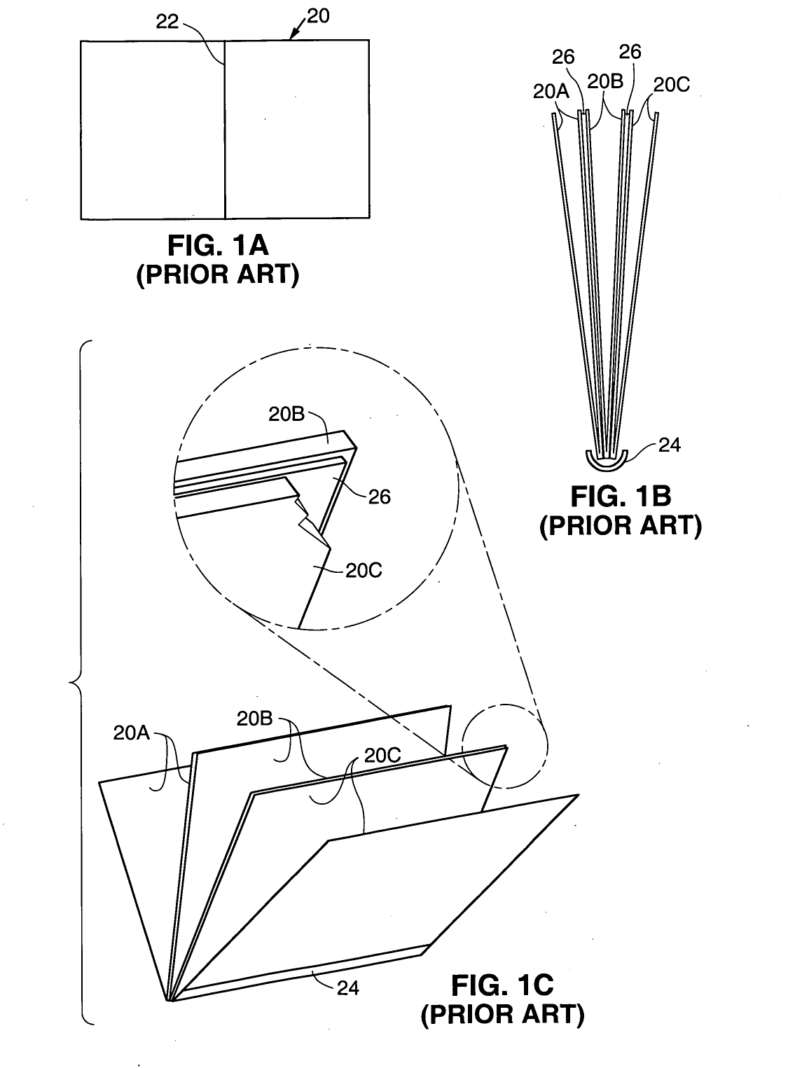

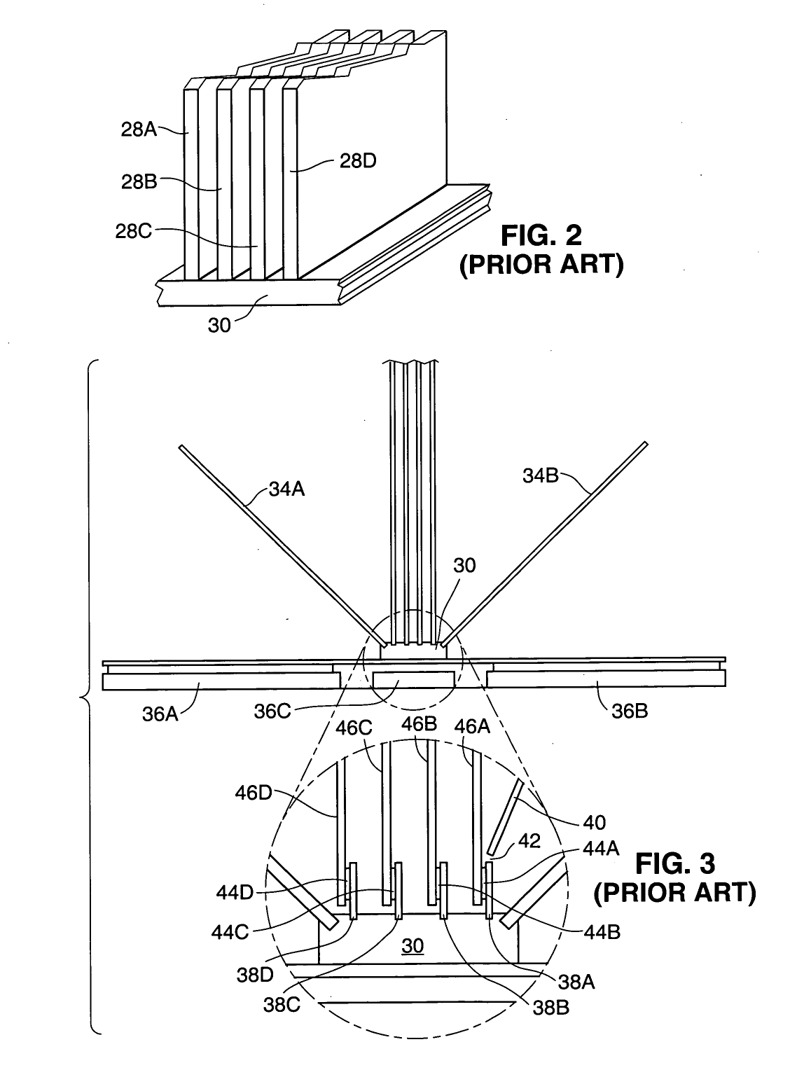

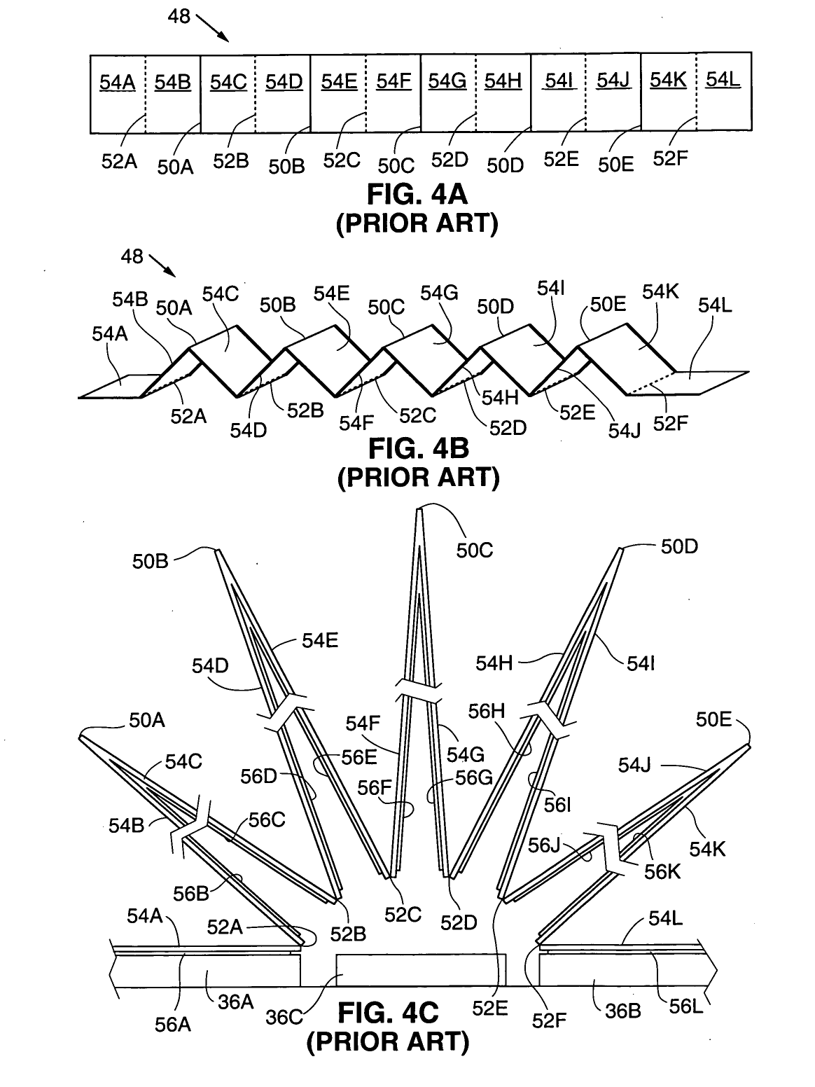

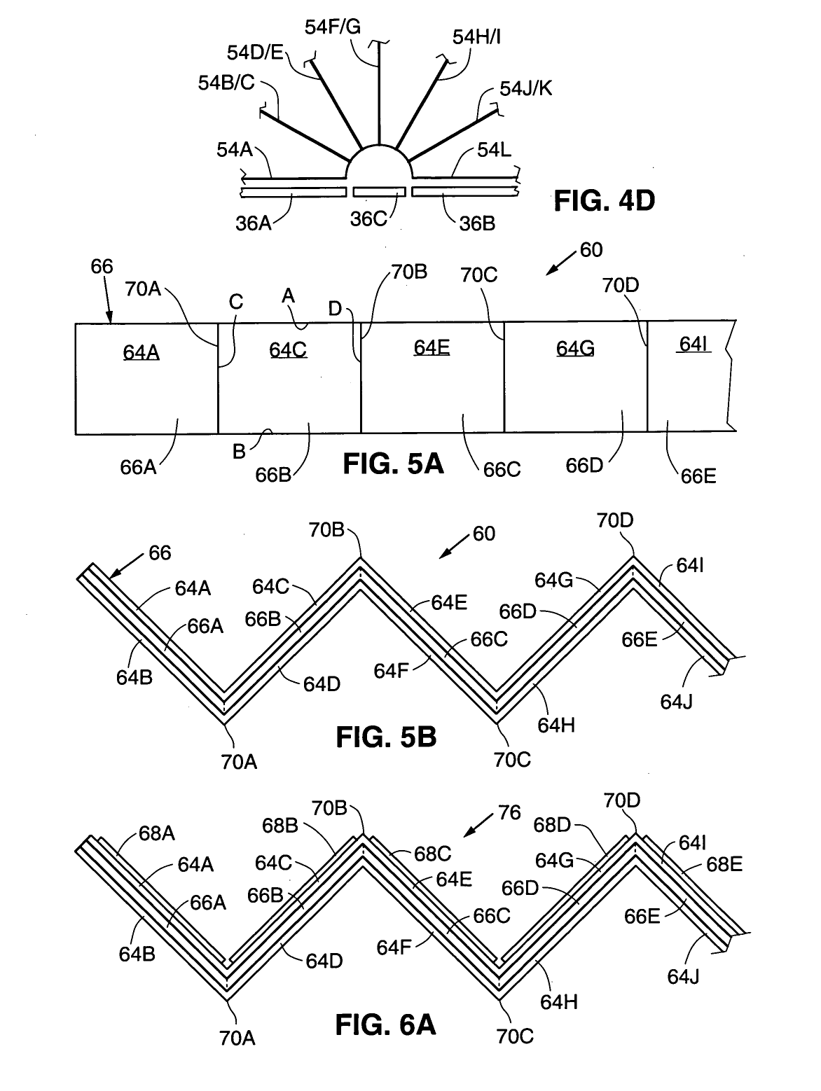

### DETAILED DESCRIPTION OF THE INVENTION

Referring again to the drawings, FIGS. 5A and 5B illustrates one embodiment of a carrier sheet arrangement 60, sometimes referred to as a carrier assembly, for forming a bound photo-album. It is to be understood that the present invention has applications other than binding photographs, including the binding of sheets that are relatively rigid and thick as compared to sheets of paper. The carrier sheet arrangement 60 is formed from a relatively heavy paper such as 80 pound weight Kraft paper which has strength and which can be readily folded to form and hold a sharp fold. The carrier sheet arrangement 60 includes generally one individual carrier sheet 66 (sheets 66A-66E) for each photograph to be bound. In some applications, the end carrier sheets 66A and 66E do not support a photograph but are used exclusively for securing the carrier sheet arrangement 60 or an end leave to a hardcover assembly. Both sides of each of the carrier sheets 66A-66E are covered by a fastening layer 64, some of which are used to secure the photographs to the carrier sheets and some of which are used to secure the carrier sheets together. In one embodiment, the fastening layers include heat activated adhesive and in another embodiment, the fastening layers include pressure activated adhesive. The pressure activated adhesive embodiment will be described first.

Each of the carrier sheets 66A-66E has dimensions close to that of the photographs to be bound. As can best be seen in FIG. 5B, the carrier sheets are preferably formed from a single piece of elongated material of Kraft paper, with the individual sheets being created by folding the elongated material at appropriate locations 70A, 70B, 70C and 70D so as to provide a fan-folded arrangement. The pressure-activated fastening layers 64 may then applied to the surfaces of the carrier sheets. As will be described in greater detail, the fastening layers 64 have a low tackiness when only small amounts of pressure are applied such as typically occur when handling the carrier sheet arrangement 60 during shipping and when initially positioning the photographs on the carrier sheets. When a relatively large amount of pressure is applied, the fastening layers become permanently highly aggressive so as to provide strong permanent adhesive bonds. Although the edges of the fastening layers 64 are shown in FIGS. 5A and 5B extending all of the way to the edges of the carrier sheets 66 on which the fastening layers are mounted, it is preferred that the fastening layers not extend all of the way to the carrier sheet edges. By way of example, the fastening layer 64C of FIG. 5A is shown having edges A, B, C and D, with those edges being depicted generally coincident with the edges of the carrier sheet 66B. However, edges C and D are each also preferably offset from the edges of the carrier 66B sheet defined by respective folds 70A and 70B by about 3/16 of an inch. Edges A and B are each preferably offset from the respective edges of the carrier sheet 66B by about 3/32 of an inch. It has been found that these offsets result in more attractive edges for the individual pages of the final product.

The carrier assembly 60 is preferably pre-manufactured and provided to an end user or assembler who assembles the photo-album for the ultimate customer. The customer typically provides the photographs for the album to the assembler. The carrier assembly 60 typically includes a large number of individual carrier sheets 66, with the assembly being cut along an appropriate one of the fold lines 70 so that the number of carrier sheets corresponds to the number of photographs to be bound. Alternatively, perforations could be added along the fold lines to that the carrier assembly sheets can be separated without cutting. As previously noted, the carrier sheets 66 are covered on both sides by a fastening layer 64. The fastening layer 64 can be implemented using either heat activated or pressure activated adhesive. The present embodiment utilizes fastening layers which incorporate pressure sensitive adhesive. As will be described in greater detail, the fastening layers are implemented to provide minimal adhesion during shipping and during the early stages of the assembly process without the use of release liners.

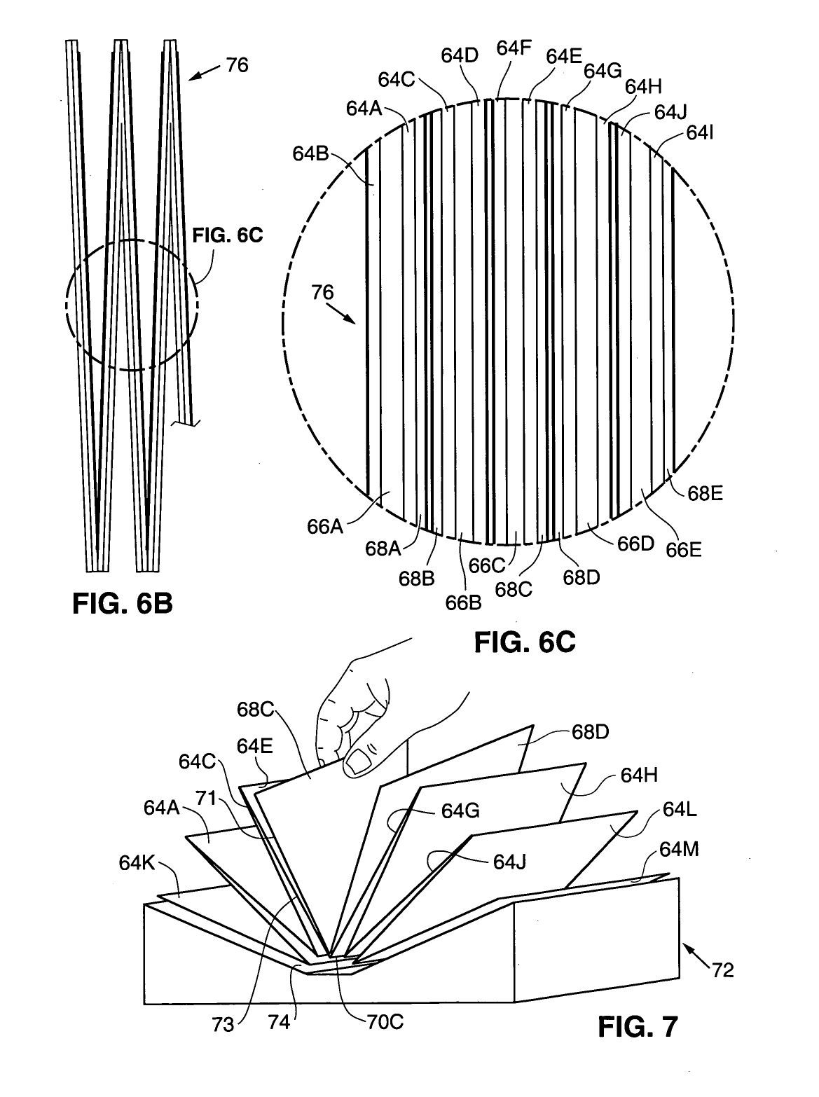

Once the proper number of carrier sheets 66 for the carrier assembly 60 has been selected, the assembler positions the photographs 68 on the carrier assembly 60 as shown in FIGS. 6A and 7. In doing so, the photographs are positioned over the carrier sheets 66, with one of the fastening layers 64 being disposed between the photograph and the carrier sheet. The end sheets of the carrier assembly 60, such as sheet 66A, function to secure the carrier assembly to either a front or rear cover of a hardcover assembly as will be described. The end sheets may or may not also support a photograph depending on the customer's choice. One advantage of the subject carrier assembly 60 is that it is easy for the assembler to accurately position the photographs, an important requirement for an attractive final product. Ease of assembly is further greatly enhanced by the fact that the fastening layers, at this stage of the assembly, provide negligible adhesion and thus do not interfere with proper positioning of the photographs.

FIG. 7 shows a caddy 72 which is preferably used for loading the photographs 68 on the carrier assembly 60. The unloaded assembly 60 is first positioned on a receiving surface 74 of the caddy 72, with the surface being shaped to hold the assembly in an almost, but not complete, open position. This is sometimes called the expanded position for the carrier assembly 60. The receiving surface 74 is also angled so that the lower portion of the carrier assembly 60, which is located near the assembly person, is lower that the upper portion of the assembly. A lower stop, not depicted in FIG. 7 supports the lower edge of the carrier assembly 60 so that the assembly does not slide off the caddy. Thus, when photographs 68 are positioned over the carrier sheets as shown in FIG. 7, the photographs tend to drop down towards the intermediate folds in the carrier assembly and remain in that position. By way of example, photographs 68C and 68D, when placed over respective fastening layers 64E and 64G of respective sheets 66C and 66D, will drop down due to gravity, with the lower edges of photographs 68C and 68B both being positioned adjacent the corresponding fold 70C of the carrier assembly.

In addition, the photographs 68 will tend to slide down to the lower stop in the caddy 72 due to gravity so that the lower edges of the photographs are aligned with the lower edges of the associated carrier sheet. This will ensure that the upper edges of the photographs, edge 71 of FIG. 7 for example, will also be aligned with the upper edges of the associated carrier sheet, edge 73 for example, since the dimensions of the carrier sheets and the photographs are the same in this direction. The dimensions of the carrier sheets are also such that when the photograph edges are positioned adjacent the associated fold, such as photographs 68B and 68C of FIG. 6A, the outer edges of the photographs do not quite reach the common fold line, such as fold line 70B. After assembly is completed and compressed, as will be described, a small section of the outer edges of each photograph together with the underlying carrier sheets near the fold lines are trimmed to provide an attractive and even exposed edge for each page of the album. Once the initial photographs have been positioned in the carrier assembly 60, gravity tends to hold the photographs in place so that the remaining photographs can be easily positioned without disturbing these previously positioned photographs.

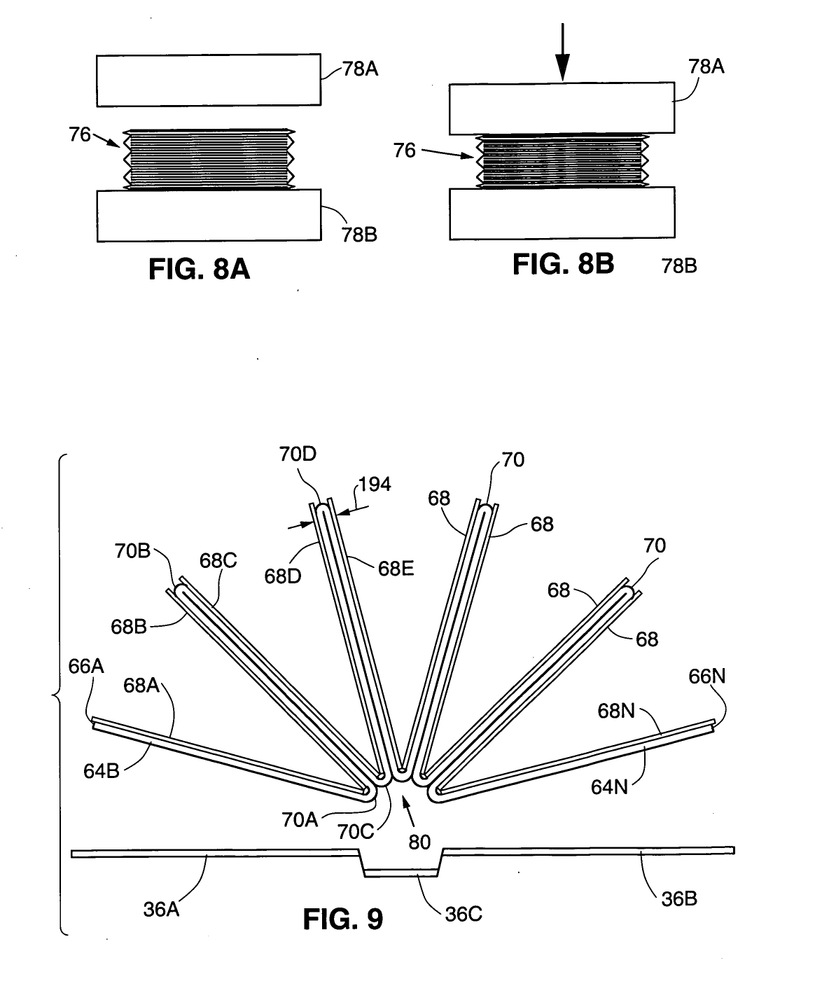

Once all of the photographs 68 have been positioned in the carrier assembly 60, the loaded assembly 76 is carefully moved from an expanded state of FIG. 7 to a compressed state as shown schematically in FIGS. 6B and 6C by manually applying a slight compression force. This force maintains the correct position of the photographs on the carrier assembly. The loaded and compressed carrier assembly 76 is then positioned between the front and back covers of a hardcover assembly so that, for example, fastening layer 64B is positioned adjacent the inside of the front cover and so that another fastening layer is positioned adjacent the inside of the rear cover. The loaded carrier assembly 76 and hardcover assembly are then transferred to a desk-top press as depicted in FIG. 8A. The press includes upper and lower plates 78A and 78B which function to apply a compression force of typically 50 to 100 pounds per square inch of carrier assembly area, with the actual force depending upon the characteristics of the fastening layers 64. As will be explained, this force will activate each of the fastening layers 64 so that the pressure sensitive adhesive in the layers will permanently secure selected components of the loaded carrier assembly together. After compression, the press is opened so that the loaded carrier assembly and hardcover can be removed.

As can be seen schematically in FIG. 6C, compression causes the various fastening layers 64 to secure selected elements of the loaded carrier assembly 76 together, with FIG. 6C showing some of the selected elements in a compressed form, a form where the photo-album is closed. FIG. 9 shows the complete photo-album, including additional pages not depicted in FIGS. 6C, in an open form, including the hard cover assembly which includes respective front and back covers 36A and 36B and intermediate spine section 36C. As can best be seen in FIG. 6C, the activated fastening layer 64B functions to secure carrier sheet 66A to the front cover 36A of FIG. 9. Another fastening layer 64, not shown in FIG. 6C, is located on the opposite side of the carrier assembly and functions to secure a carrier sheet assembly to the back cover 36B. Thus, the hardcover assembly is secured to the carrier assembly at the front and back cover sections and not to the spine section 36C so that the album will tend to lay flat when fully opened as shown in FIG. 9.

Continuing, after compression fastening layer 64A will become activated and will function to secure photograph 68A to the carrier sheet 66A. Thus, the inner side of the front cover 36A will display photograph 68A. In addition, fastening layer 64C will secure photograph 68B to carrier sheet 66B and fastening layer 64E will secure photograph 68C to carrier sheet 66C. Continuing, fastening layers 64D and 64F will function together to secure the backsides of carrier sheets 66B and 66C together so that photographs 68B and 68C, together with intermediate carrier sheets 66B and 66C, form a single page of the album. That page includes photograph 68B on one side and photograph 68C on the opposite side. Similarly, photographs 68D and 68E, together with intermediate carrier sheets 66D and 66E, form a further page of the album. The album would typically include other carrier sheets of the carrier arrangement 60 along with associated photographs so that the album would include additional pages as shown in FIG. 9.

As can also be seen in FIG. 9 and as previously noted, the fastening layers 64 function to secure front and back carrier sheets to the inner surface of the respective front and back cover sections 36A and 36B. Further, the fastening layers 64 function to secure selected adjacent carrier sheets together to form a flexible spine 80. By way of example, fastening layers 64D and 64F secure the entire respective surfaces of carrier sheets 66B and 66C together so that the fold lines 70A and 70C are disposed adjacent one another to form a single page. The single pages are all secured together at the spine 80 by the carrier assembly itself. Note that it would be possible to pre-manufacture the carrier assembly 60 so that the carrier sections that become secured together along the full surface, such as carrier sections 66B and 66C, are glued together using conventional book binding adhesives or the like. In that event, certain fastening layers, such as layers 64D and 64F, can be deleted from the carrier assembly 60 provided to the assembler. As previously noted, it is preferably that the outer edges of the pages that make up the album be trimmed. As indicated by arrow 194 of FIG. 9, the page is trimmed so as to remove part of the photographs 68D and 68E and part of the underlying folded carrier sheets which form fold 70D so that the material forming the fold is removed. This cut is preferably not so deep as to expose the underlying pressure sensitive adhesive which, as previously described, terminates about 3/16 of an inch from the fold 70D. This presents an attractive even edge free of adhesive, so that the edge does not attract debris and the like which could possibly adhere to any exposed adhesive. As also previously noted, the adhesive of the fastening layer is displaced typically 3/32 of an inch from the edges that form the top and bottom of the album pages thereby further proving an attractive edge free of any collected debris.

Details regarding the construction of the fastening layers 64 will now be provided. As previously noted, an objective of the fastening layers 64 is to provide negligible adhesion when the layer is subjected to low forces such as are present when the carrier assembly 60 is shipped and when photographs 68 are being positioned on the carrier assembly. Any significant adhesion would, for example, greatly complicate accurate positioning of the photographs.

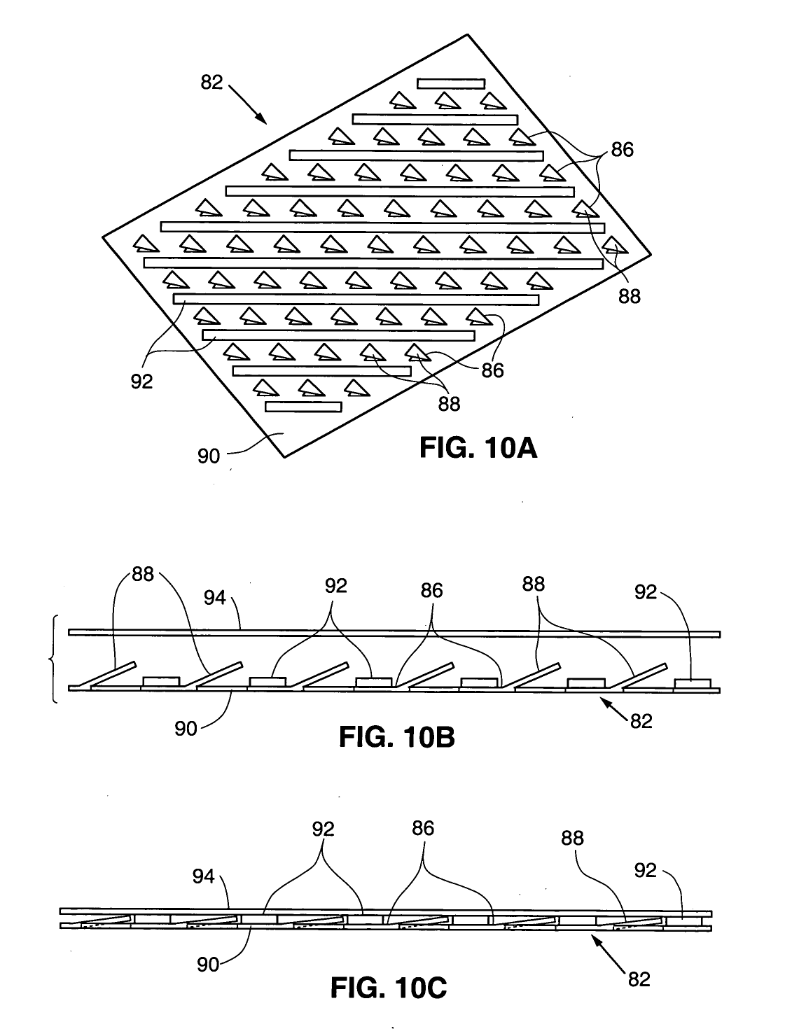

FIGS. 10A, 10B and 10C illustrate one embodiment of the subject fastening layers, sometimes referred to as the flap style fastening layer 82. As is the case for many of the fastening layer embodiments, fastening layer 82 utilizes part of the underlying carrier sheet designated sheet 90. As can best be seen in FIG. 10A, fastening layer 82 includes an array of generally triangular shaped flap members 88 (not all are designated) cut into the carrier sheet 90. The flap members 88 remain secured to the carrier sheet by way of hinge sections 86 (not all designated) so that the flap members can move between a folded upright position as shown in FIGS. 10A and 10B and a flattened position as shown in FIG. 10C. A small but finite force is required to displace each of the flap members 88 from the upright to a more flattened position. The flap members 88, which are sometimes referred to collectively as the support structure, are arranged in an array, with there typically being at least one flap member per square inch of fastening layer 82 area and preferably approximately 25 members per square inch.

Fastening layer 82 further includes a layer of pressure sensitive adhesive such as a hot melt pressure sensitive adhesive sold by HB Fuller under the designation HM-2713. Unless noted otherwise, a thickness of the pressure sensitive adhesive layer for the various embodiment fastening layers ranging from 1 to 1½ mils has been found to be satisfactory, with this thickness being adjustable to alter the characteristics of the fastening layer as needed. The adhesive layer includes several individual adhesive strips 92 disposed on the surface of the carrier sheet intermediate the array of flap members 88. When the carrier sheet is manufactured, the flap members 88 are positioned (folded) to extend away from the carrier sheet in an upright position and to extend through and past the upper surface of the adhesive layer comprised of adhesive segments 92. Thus, if some generic compressing sheet 94, such as a photograph or the like, is resting on the fastening layer 82, the support structure formed by the various upright flap members 88 will prevent the compressing sheet 94 from contacting the upper surface of the adhesive layer as defined by adhesive segments 92. Thus, the compressing sheet 94 does not adhere to the fastening layer or the underlying carrier sheet. However, if a large compression force were applied to the fastening layer 82 by way of a compressing sheet 94, the force would be sufficient to displace the support structure, that is, sufficient to force the flap members 88 down below the upper surface of the adhesive layer 92 thereby exposing the adhesive layer so that the layer can function to secure the compressing sheet 94 to the underlying carrier sheet 90 as shown in FIG. 10C. Although the adhesive layer of fastening layer is comprised of disconnected adhesive segments 92, it would be possible to use other configurations of adhesive intermediate flap members 88 including a single connected adhesive grid extending over substantially the entire surface of the carrier sheet 90 intermediate the flap members.

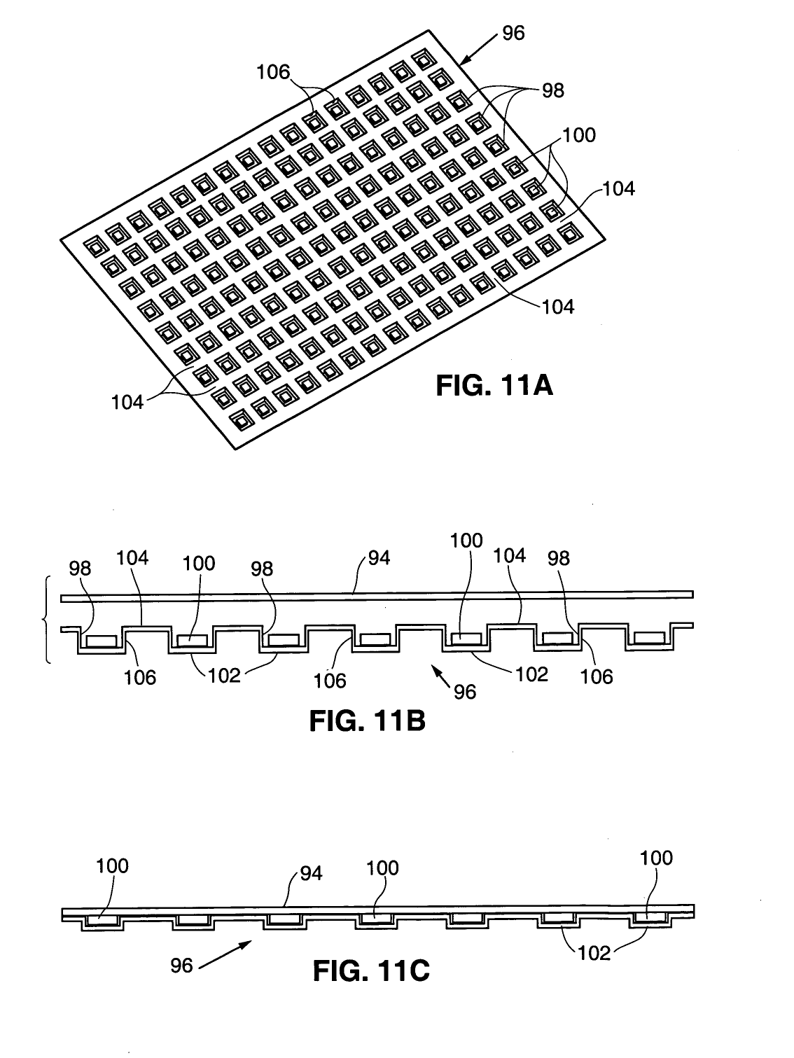

A further fastening layer embodiment is shown in FIGS. 11A, 11B and 11C. This embodiment, sometimes referred to as the well type fastening layer 96, also uses part of the underlying carrier sheet to form the support structure. The well fastening layer 96 includes an array of wells 98 (not all designated) typically created by deforming the carrier sheet. The wells 98 are arranged in an array, with the well density typically being at least one well for each square inch of fastening layer area and preferably approximately 25 wells for each square inch of area. A segment 100 of pressure sensitive adhesive is disposed in each well 98, with the adhesive segments together forming a layer of pressure sensitive adhesive. The bottom portions 102 of the wells together form the carrier sheet upon which the fastening layer 92 is disposed.

The fastening layer 96 includes a support structure which includes the raised region 104 intermediate the wells and the well wall members 106 (not all designated) which extend up from the surface supporting the adhesive segments 100 and past the upper surface of the adhesive segments. Thus, when a generic compressing sheet 94, such as a photograph, is resting on the fastening layer 96, the support structure, which includes raised region 104 and wall members 106, prevents the sheet from contacting the adhesive layer 100. Thus, the sheet 94 will not adhere to the underlying carrier sheet 102. However, should a substantial amount of pressure be applied to the compressing sheet 94, the support structure 104/106 will be displaced so that the upper surface of the adhesive layer formed by pressure sensitive adhesive segments 100 will contact sheet 94 as shown in FIG. 11C. Thus, the sheet 94 is secured to the underlying carrier sheet formed by well bottom portions 102.

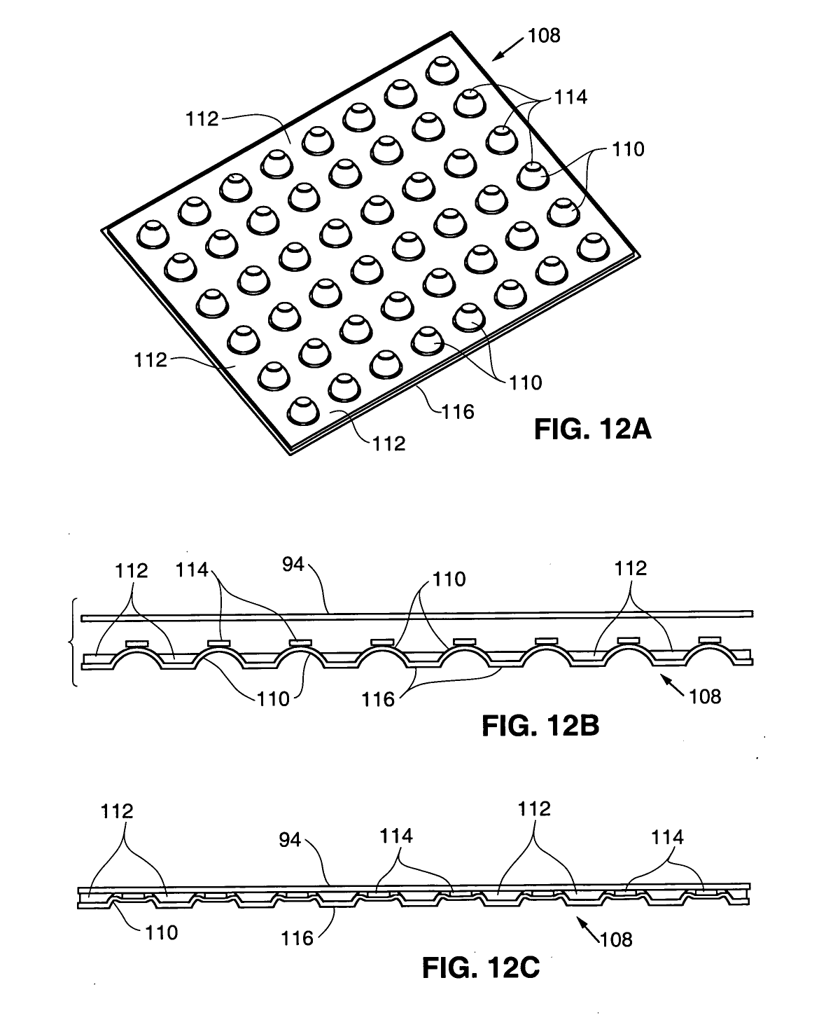

A still further fastening layer embodiment 108 is shown in FIGS. 12A, 12B and 12C. This embodiment, sometimes referred to as the raised area type fastening layer 102, also uses part of the underlying carrier sheet for part of the support structure. Fastening layer 108 includes an array of raised areas 110 (not all designated) typically created by deforming the carrier sheet. The raised areas 110 are arranged in an array, with the raised area density typically being at least one raised area for each square inch of fastening layer area and preferably approximately 25 raised areas for each square inch of area. The regions intermediate the raised areas 110 form the carrier sheet 116. A layer 112 of pressure sensitive adhesive is supported on the carrier sheet 116, extending around each of the raised areas 110.

The fastening layer 108 includes a support structure which includes the raised regions 110 in combination with a separate support member 114 supported on each raised member. The support members 114 are preferably made from material having a silicone treated surface and are solid so that they do not compress when typical forces are applied in the press. Each support member is held in place by a thin layer of pressure sensitive adhesive (not depicted) which can be an extension of adhesive layer 112. The upper surfaces of the support members 114 initially extend past the upper surface of the adhesive layer 112. Thus, when a generic compressing sheet 94, such as a photograph, is resting on the fastening layer 108, the support structure, raised regions 110 and support members 114, prevent the sheet from contacting the adhesive layer 112. Thus, the sheet 94 will not adhere to the underlying carrier sheet 116. However, should a substantial amount of pressure be applied to the compressing sheet 94, the support structure 114/110 will be displaced, with the support members 114 functioning to collapse the associated raised areas 110. This results in the upper surface of the adhesive layer 112 contacting sheet 94 as shown in FIG. 12C. Thus, the sheet 94 is secured to the underlying carrier sheet 116.

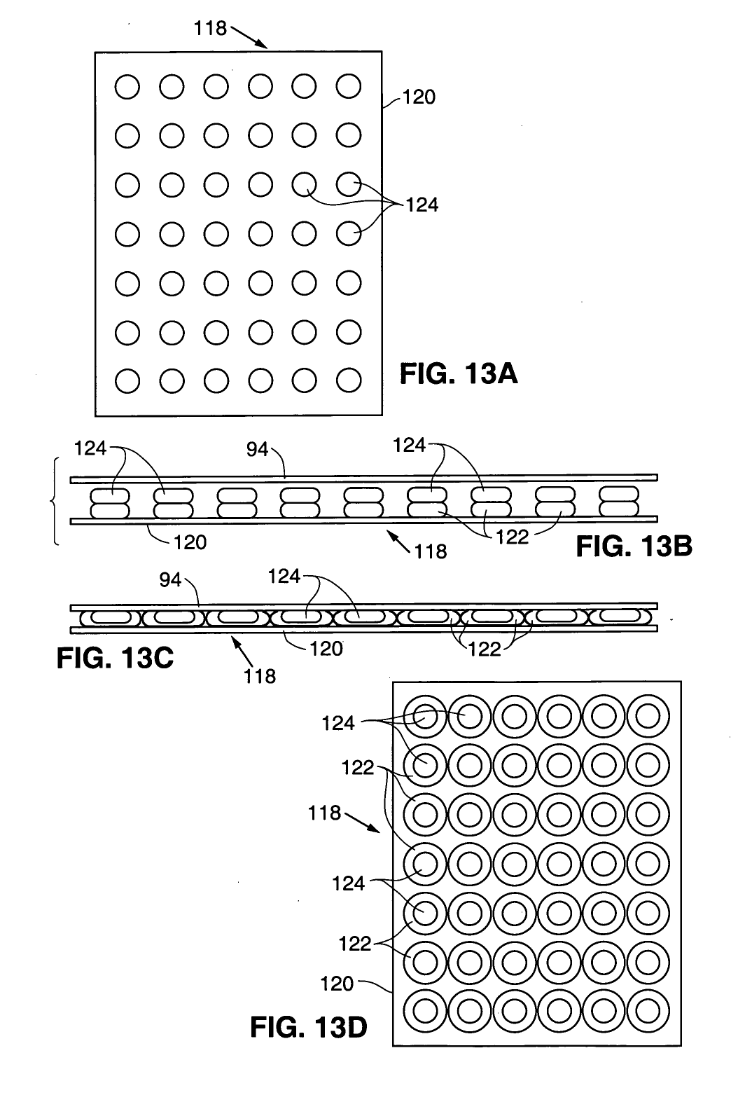

As still further embodiment fastening layer 118 is shown in FIGS. 13A, 13B, 13C and 13D. Unlike the previous embodiments, this embodiment utilizes a support structure that is separate from the underlying carrier sheet 120. As can best be seen in FIG. 13B, an array of spaced-apart pressure sensitive adhesive segments 122 is positioned over the surface of the carrier sheet 120, with the array having a density of at least one segment per square inch of carrier sheet 120 area and preferably approximately 25 segments per square inch. The array of segments 122 forms a layer of pressure sensitive adhesive. The support structure includes an array of support members 124, much like support members 114 of the FIG. 12A embodiment. A support member 124 is disposed over each of the adhesive segments 122. When a generic compressing sheet 94, such as a photograph, is resting on the fastening layer 118, the support members 124 initially prevent the sheet 94 from adhering to the adhesive layer. The thickness of the layer formed by adhesive segments 122 is preferably about 4 mils.

However, when a substantial compression force is applied through the compressing layer, the support members 124 are forced down into the associated adhesive segment 122. As can best be seen in FIGS. 13C and 13D, the downward displacement of the support members causes the adhesive segments 122 to expand laterally, with the gaps between the segments providing space for this expansion. The net result is that the upper surface of the support members 124 falls below the upper surface of the adhesive layer so that the compressing sheet 94 becomes secured to the adhesive layer and underlying carrier sheet 120.

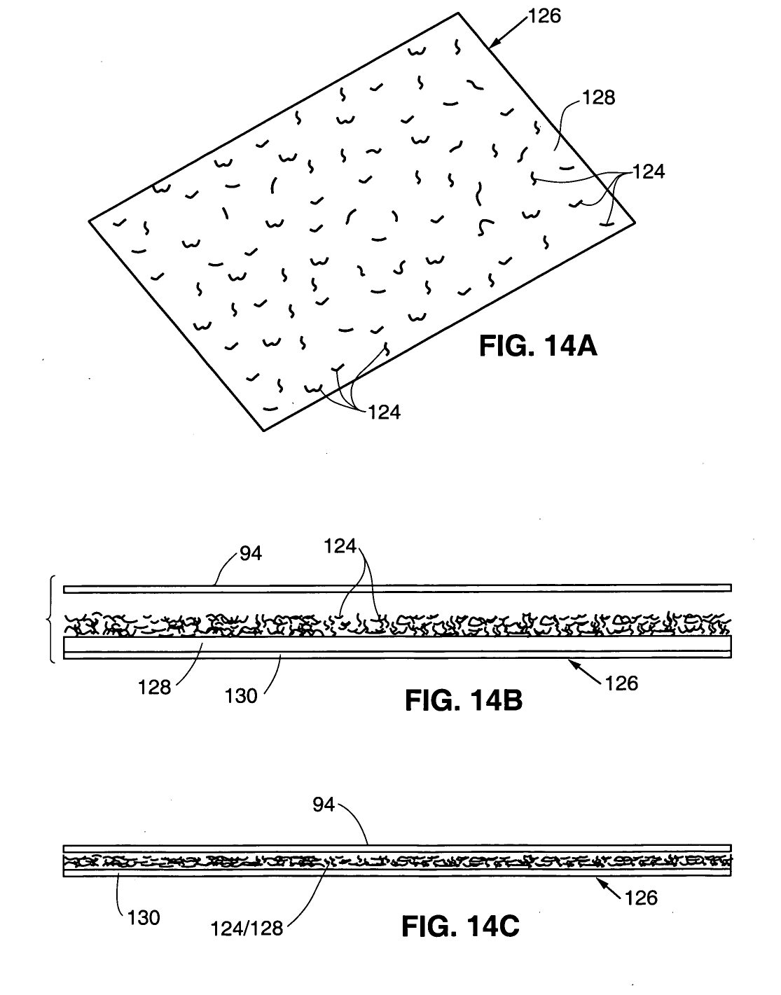

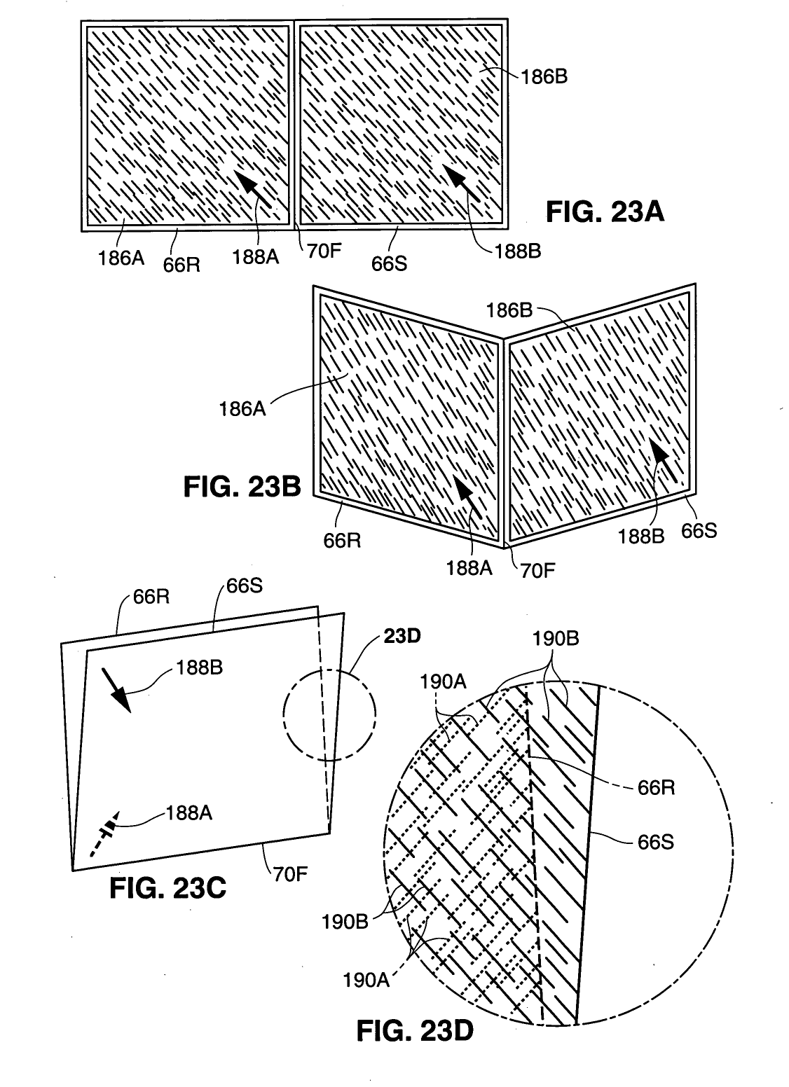

Continuing, a further alternative fastening layer 126 is shown in FIGS. 14A, 14B and 14C. As shown in FIG. 14B, the fastening layer 126 is supported on a carrier sheet 130 and a layer of pressure sensitive adhesive 128 extending over the carrier sheet. A layer of non-woven fabric 124, typically in the form of loosely coupled individual fibers, is disposed over the adhesive layer 128 to form the support structure. The fibers could also be separate fibers such as flock. Layer 124 could also comprise woven fabric that is highly porous such as cheesecloth. Depending upon the thickness of the woven fabric, it may be necessary to increase the thickness of the pressure sensitive adhesive layer 128 to about 4 mils. When a generic compressing sheet 94, such as a photograph, is resting on the support structure 124, the fibers of the structure that are present on the upper surface of adhesive layer 128 prevent the sheet from significantly adhering to the adhesive. Further details regarding the use of flock for the support structure will be provided in connection with the discussion relating to FIGS. 23A-23D.

When a substantial compression force is applied, the fibers in layer 124 are forced into the adhesive layer 128 as can be seen schematically in FIG. 14C so that a substantial portion of the adhesive is exposed so that it can contact compressing sheet 94. Thus, sheet 94 is secured to the underlying carrier sheet 130 by way of the adhesive.

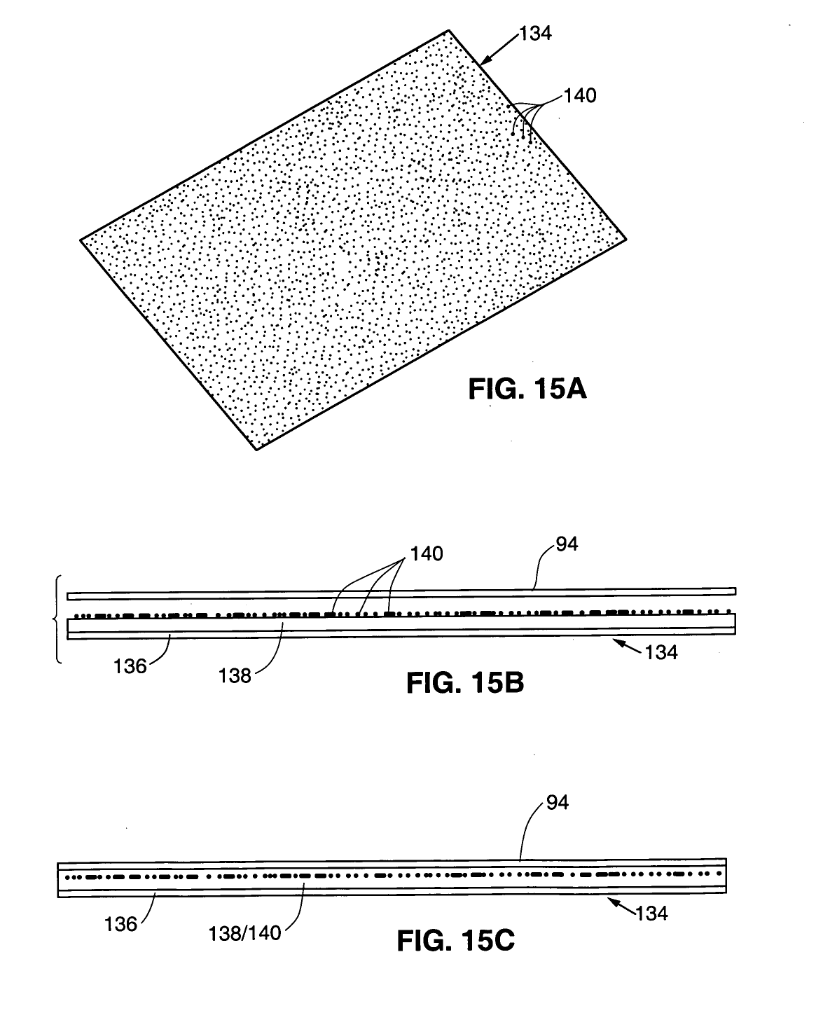

An additional fastening layer embodiment 134 is depicted in FIGS. 15A, 15B and 15C. As can best be seen in FIG. 15B, fastening layer 134 is supported on a carrier sheet 136 which supports a layer 138 of pressure sensitive adhesive. A layer 140 of granulated material such as sand, pumice, diatomaceous earth or talcum powder, functions as the support structure. The granules 140 are positioned at the upper surface of the adhesive layer 138 and prevent a generic compressing sheet 94 from contacting the adhesive layer when the compressing sheet is merely resting on the fastening layer 134. However, when a substantial compression force is applied through the compressing sheet, the granules are displaced from the upper surface and forced down into the adhesive layer as can be seen schematically in FIG. 15C. This results in a quantity of the pressure sensitive adhesive 138 being in a position to contact the compressing sheet 94 thereby securing the compressing sheet to the carrier sheet 136.

The various embodiments of pressure sensitive adhesive based fastening layers disclosed herein are particularly suitable for the present application of securing photographs to a carrier. First, it is important that the adhesion strength of the fastening layers be small at applied forces expected to be incurred during shipping of the carrier assembly 60 (FIG. 5B) and during assembly when photographs 68 are positioned on the carrier assembly and when the assembly is transferred to the press 78 (FIGS. 8A and 8B). Second, it is important that the adhesion strength be substantial after the fastening layer is activated by application of a relatively large force such as is provided by press 78.

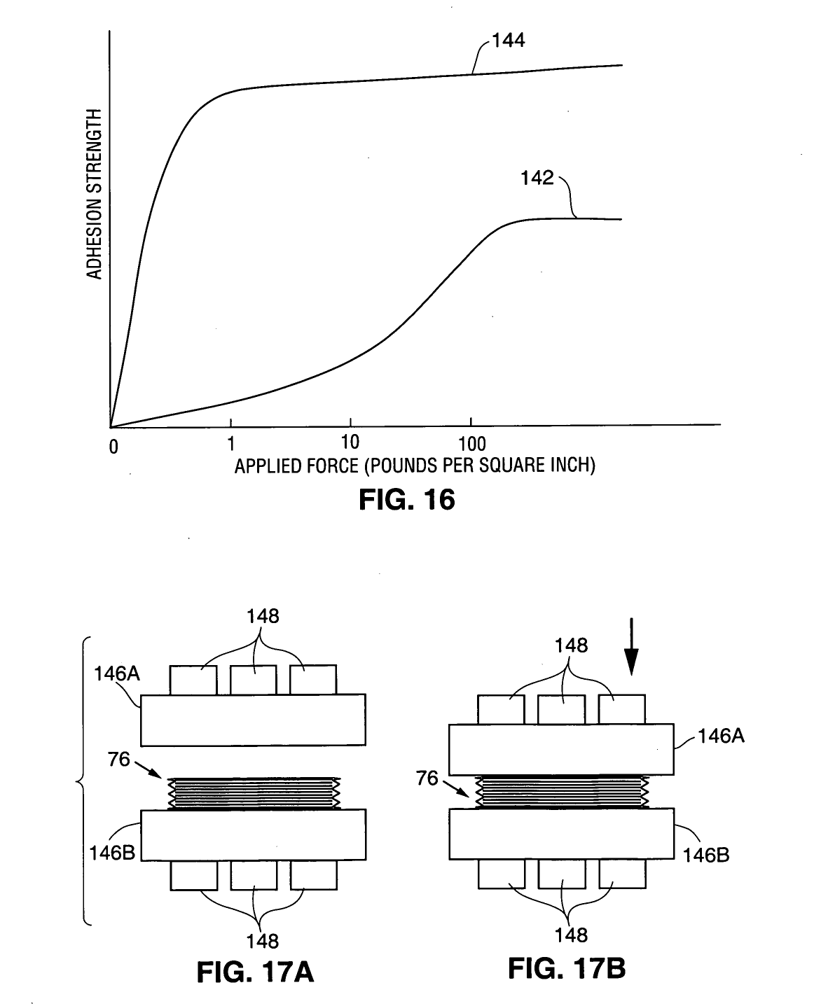

FIG. 16 is a graph having a curve 142 illustrating the adhesive qualities of an exemplary fastening layer 82 showing adhesion strength versus applied force per unit area. Also shown for purposes of comparison is a curve 144 for an exemplary conventional pressure sensitive adhesive. It can be seen from curve 144 that the conventional adhesive provides a relatively large amount of adhesion strength for small amounts of applied force, with the adhesion strength not increasing significantly for large amounts of applied force. The subject fastening layer exemplary curve 142 provides an insignificant amount of adhesion strength at low applied force, with increases in force resulting in a corresponding increase in adhesion strength. It can be seen that a conventional pressure sensitive adhesive provides significantly greater adhesion strength than does the subject fastening layer after application of substantial compression forces. The final adhesion strength is sufficient for many applications, such as those described herein, so the smaller strength is not a significant shortcoming.

The shape of curve 142 can be readily adjusted depending upon the type of fastening layer and depending upon the manner in which the fastening layer is implemented. By way of example, for the embodiment of FIGS. 10A, 10B and 10C, the slope of the curve 142 will be somewhat steeper once the adhesive layer starts becoming activated as compared to the FIG. 14A, 14B and 14C embodiment 126. That is, the rate of increase in adhesion strength is generally larger. Also, the maximum adhesion strength of fastening layer 82 can be increased by increasing the total area and number of the adhesive segments 92. The point at which fastening layer is activated, that is, the point at which the adhesion strength becomes significant can be reduced or increase by changing the number of flap members 88. The activation point can also be increased or decreased by selecting carrier sheet materials 90 of greater or lesser resiliency. Equivalent adjustments could also be made, for example, to the fastening layer 96 (FIGS. 11A, 11B and 11C) and fastening layer 108 (FIGS. 12A, 12B and 12C). As a further example, the point at which the fastening layer embodiment 126 (FIGS. 14A, 14B and 14C) and embodiment 134 (FIGS. 15A, 15B and 15C) are activated can be adjusted by altering the volume of fabric 124 or volume of granulated material 140 or the physical properties of these items along with the thickness of the respective adhesive layers 128 and 138.

The fastening layers, when used in applications for fabricating photo-albums and the like, preferably have adhesion properties such that the adhesion strength increases by at least a factor of 10 when applied compression force of 2.0 pounds per square inch is increased to 25.0 pounds per square inch. Of course, the actual compression force applied to the various embodiments of the fastening layer during use can vary depending upon various factors including the manner in which the layer is actually implemented. For example, a fastening layer having the above-noted adhesion properties may be secured using a force less than or greater than 25.0 pounds per square inch.

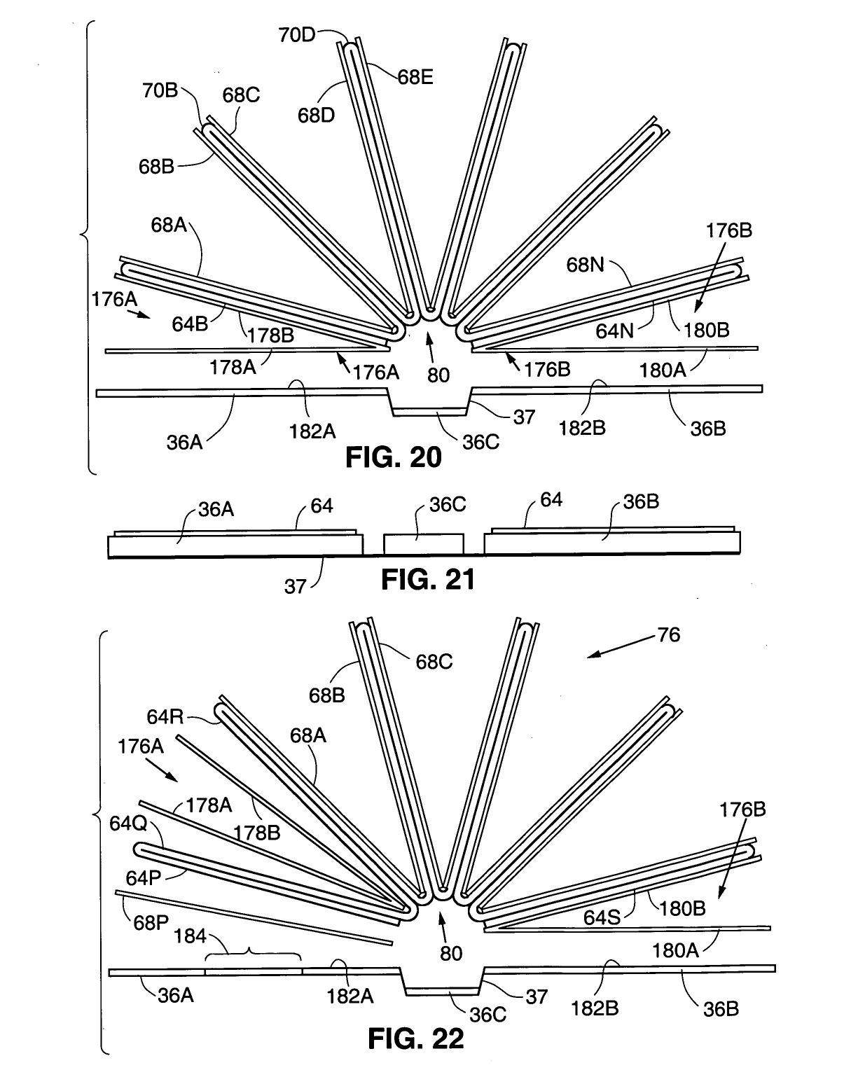

As previously described, a hardcover assembly can be applied by way of the pressure sensitive adhesive based fastening layers, such as layer 64B of FIGS. 6A and 6B. In that event, the loaded carrier assembly 76 is installed between the front and rear hardcover sections 36A and 36B (FIG. 9) prior to placing the carrier assembly in the press 78. Alternatively, the hardcover assembly can be applied after the carrier assembly 76 has been compressed. Rather than using the fastening layers 64 for securing the hardcover assembly, the assembly is provided with layers 182A and 182B of conventional pressure sensitive adhesive being disposed on the interior sides of the front and rear covers 36A and 36B as shown in FIG. 20. Release liners (not depicted) cover the pressure sensitive adhesive prior to assembly. Such an arrangement is shown, for example, in Patent Application Publication US 2004/0067123 A1 published Apr. 8, 2004 based upon application Ser. No. 10/385,960 filed on Mar. 10, 2003, the contents of which are fully incorporated herein by reference. Preferably, a pair of end leaves 176A and 176B are provided as shown schematically in FIG. 20 which are positioned on opposite sides of the loaded carrier assembly prior to the compression step. End leave 176A is folded to provide two end sheets 178A and 178B, each of which is essentially the same size as the individual carrier sheets 66 of the assembly upon which the photographs are to be secured. Similarly, end leave 176B is folded to provide two end sheets 180A and 180B. The end leaves 176A and 176B are positioned on opposite sides of the carrier assembly with the outer carrier sheets each being provided with a fastening layer 64B which faces end sheet 178B and fastening layer 64N which faces end sheet 180B of the corresponding end leave.

With the loaded carrier assembly 76 and end leaves 176A and 176B held in position, the arrangement is placed in the plate 78B of the press so that a compressing force can be applied as previously described. The fastening layers are thus activated thereby securing the photographs and carrier sheets together and also securing leaves 178B and 180B to the assembly 76. A hardcover, including front and back cover sections 36A and 36B and spine section 36C is then applied to the bound combination as described in detail in the above referenced Patent Application Publication US 2004/0067123 A1. As previously noted, the interior surface of the front cover section 36A and the interior surface of the back cover section 36B are both covered with a layer of respective pressure sensitive adhesive 182A and 182B, with the layers of adhesive completely covered by respective release liners (not depicted). During this process of installing the assembly 76 and end leaves 176A/B in the hardcover assembly, end leave sheet 178A is attached to front cover section 36A by removing the release liner and carefully positioning assembly 76 and end leaves 176A/B, collectively the stack, over the front cover section so that sheet 178A will be completely adhered to cover section 36A by the pressure sensitive adhesive 182A. Sheet 180A is then applied to cover section 36B by removing the release liner from section 36B and folding the section over the bound assembly so that sheet 180A is contacted by the exposed pressure sensitive adhesive 182B on the inner surface of rear cover section 36B. Preferably a guide apparatus is used in this process as also disclosed in the above-noted Patent Application Publication US 2004/0067123 A1 since it is very difficult to reposition the stack to be bound once part of the stack has contacted the pressure sensitive adhesive. When completed, the bound stack is secured to the hardcover assembly only by way of the end leaves 176A and 176B.

FIG. 21 shows an alternative hardcover assembly that includes front and back relatively rigid cover sections 36A and 36B and an intermediate spine section 36C. Typically the front and back cover sections are secured together by a flexible membrane 37 such as fabric or the like. Rather than utilizing a pressure sensitive adhesive located on the interior surface of the hardcover assembly as previously described in connection with FIG. 20, the hardcover assembly is provided with two of the previously described pressure sensitive adhesive based fastening layers 64 as shown in FIG. 21. In that event, the loaded carrier assembly 76 is positioned intermediate end leaves 176A/B. That arrangement is then accurately positioned over the fastening layer 64 on the front cover section 36A so that sheet 178A contacts the fastening layer. This step is greatly simplified since the assembler does not have to contend with aggressive pressure sensitive adhesive during the positioning. Next, the rear cover section 36B is folded over onto the stack so that the fastening layer 64 on section 36B will contact sheet 180A. Again, accurate positioning is not difficult since the fastening layer is not tacky at this stage. Thus, the need for the previously described guide apparatus is reduced or even eliminated. The entire assembly is then positioned in the press so that all of the fastening layers will be activated thereby securing the various components together, including securing the end sheet 178A to cover section 36A and securing end sheet 180A to cover section 36B. The hardcover assembly of FIG. 21 could also be used for covering other bound stacks assembled using conventional binding methods rather than the disclosed pressure sensitive adhesive based fastening layers.

It is also possible to produce a photograph album or the like where a photograph can be viewed through an opening or window formed in the front cover section of the hardcover assembly. As can be seen in FIG. 22, a hardcover assembly is provided with a window 184 in the front cover section 36A. A photograph 68P is provided, with the photograph having an image sized and positioned so that it can be viewed through window 184 when the photograph is correctly positioned over the inner surface of the front cover section 36A. The carrier assembly includes one page formed by two folded carrier sheets, with each sheet having an associated fastening layer 64P and 64Q. As shown in FIG. 22, an end leave 176A is positioned intermediate to adjacent pages of the carrier assembly so that sheet 178A is facing fastening layer 64Q and so that sheet 178B is facing another fastening layer 64R of an adjacent carrier assembly page. A second end leave 176B is positioned intermediate the front cover section 36B and a page of the carrier assembly supporting a fastening layer 64S.

The loaded carrier assembly 76, end leaves 176A and 176B, together with photograph 68P, are arranged relative to one another as shown in FIG. 22 and manually forced together so that the arrangement can be placed in a press as shown in FIGS. 8A/B and compressed so that all of the fastening layers 64 are activated. Among other things, this action allows the photograph 68P to be displayed while being secured to end leave 178A by way of fastening layers 64P and 64Q. In addition, fastening layer 64S functions to secure end sheet 180B to the last page of the bound carrier assembly. The bound arrangement is then positioned in the hardcover assembly in the same manner as previously described in connection with FIG. 20. Thus, the image surface of photograph 68P is secured to the inner surface of front cover assembly 36A by the pressure sensitive adhesive layer 182A, except where the viewing window 184 is located. In addition, end leave sheet 178A is secured to the rear of photograph 68P by way of fastening layers 64P and 64Q. Similarly, end leave sheet 180A is secured to the inner surface of back cover section 36B by way of pressure sensitive adhesive 182B. It would also be possible to substitute the carrier assembly of FIG. 22 utilizing pressure sensitive adhesive layers 182A and 182B with fastening layers as previously described in connection with FIG. 21. In that event, the entire arrangement, including the hardcover assembly, is placed in the press for activating all of the fastening layers.

As previously described in connection with the fastening layer embodiment 126 of FIGS. 14A/B/C, fibers can be used to form the support structure of the fastening layer. Flock has been found to be particularly suitable for this application. Flock in the form of precision cut monofilament micro-fibers of cotton, rayon or acrylic can be used. The diameter of the individual flock strands is only a few thousandths of a centimeter, with the length typically ranging from 0.25 to 5 mm. A quantity of flock is evenly applied to the underlying layer of pressure sensitive adhesive so that part of the flock is attached to the layer. A soft brush can then be used to remove the excess flock. FIGS. 23A/B/C/D depict an exemplary pair of carrier sheets 66R and 66S connected by a fold 70F, with this arrangement forming all or part of a carrier assembly. Each carrier sheet 66R and 66S is provided with a respective fastening layer 186A and 186B which includes flock for the support structure, with the length of the fibers being greatly exaggerated for purposes of clarity. As previously explained, the fastening layers are implemented to provide little adhesion strength at low pressures so that, for example, a photograph can easily be positioned and repositioned. However, when the carrier arrangement is folded as shown in FIG. 23C for shipping and the like there may be some tendency for the layers 186A and 186B to adhere to one another. This tendency can be reduced by applying the flock to the adjacent carrier sheets such as sheets 66R and 66S so that fibers are ideally aligned at right angles to one another. The orientation of the flock fibers can be controlled by using fibers covered with a conductive coating and then depositing the fibers on the pressure sensitive adhesive layer using well known electrostatic application processes. As a result, the deposited fibers all tend to be positioned standing upright. Next, the upright fibers are then by brushing the fibers with a brush in a single direction. For reasons that will be explained, the directions should be other than parallel to fold 70F. By way of example, the fibers of fastening layer 186B are brushed in a direction indicated by arrow 188B, with the direction being about 45 degrees towards the fold 70F. This tends to orient the fibers in the direction of the arrow 188B. Similarly, the upright fibers of fastening layer 186A are brushed in the direction of arrow 188A which is a direction of about 45 degrees away from fold 70F. When the carrier sheets 66R and 66S are folded over one another as shown in FIG. 23C as they would be, by way of example, in shipping, the fibers tend to be normal to one another as represented in FIG. 23D. The fibers 190B from fastening layer 186B, which are represented by relatively thick lines, are generally at right angles to fibers 190A from fastening layer 186A, with the fibers 190A being represented by relatively thin lines. Any deviation of fiber orientation from random will provide some benefit, with the orientation preferably being between 70 and 90 degrees for a majority of the fibers on the opposing fastening layers. If the fibers are brushed in a direction parallel to the fold 70F, it can be seen that fibers of the two sheets will remain parallel, something not desired, when the sheets are folded.

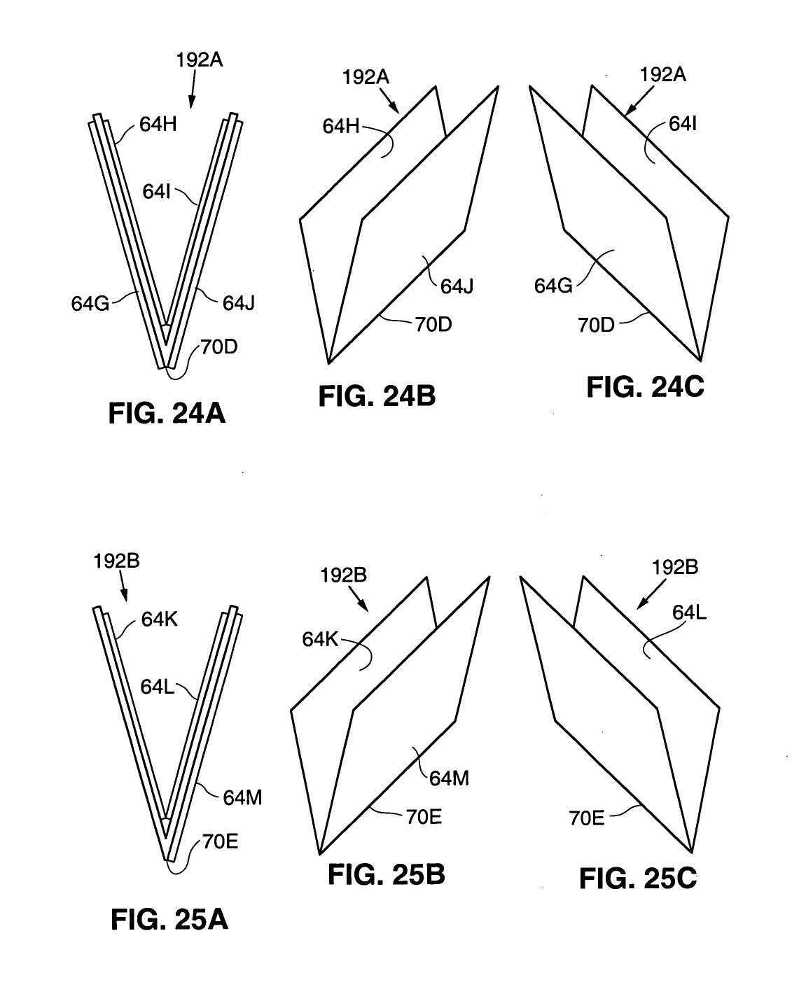

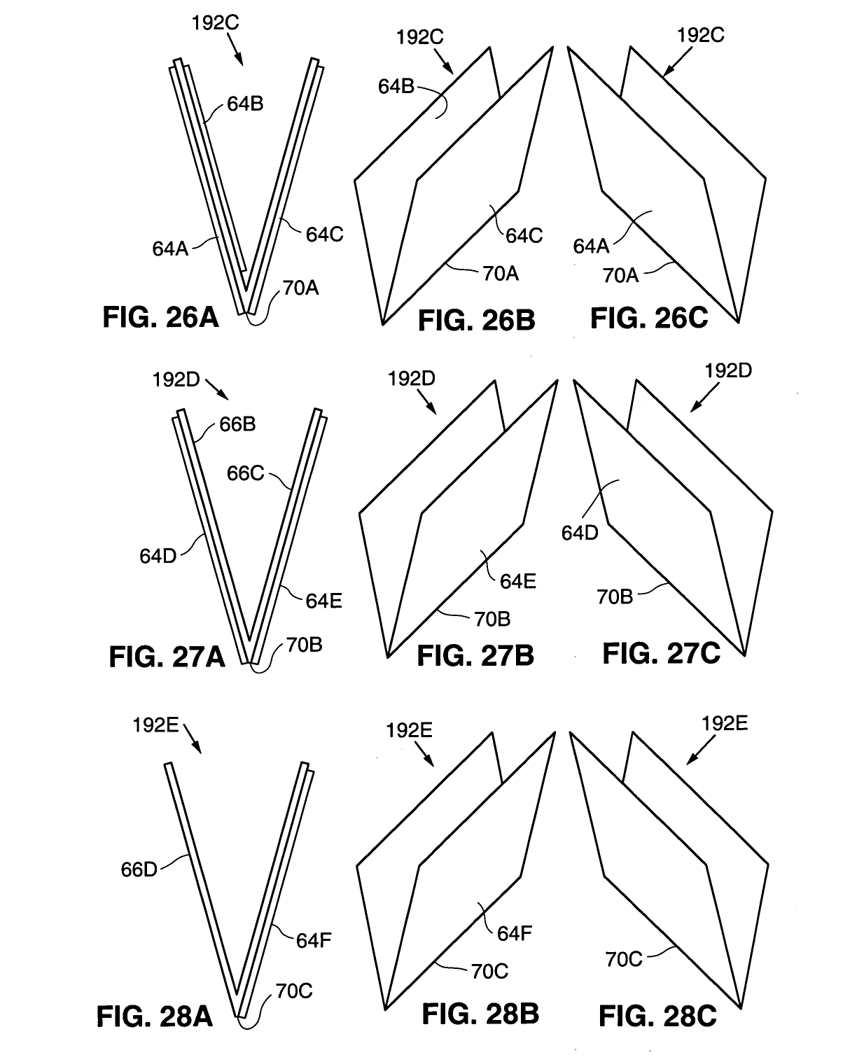

Although a carrier assembly 60 having more than two sheets 66, such as FIG. 5B, has been described, it would be possible to create an album using a collection of one or more carrier assemblies, with each of the assemblies including only two sheets separated by a fold. As will be seen, two sheet carrier assemblies can be implemented in differing manners so that a wide variety of photo-albums can be created. FIGS. 24, 25, 26, 27 and 28 depict five different two sheet carrier assemblies which can be combined to create different photo albums. FIGS. 24A, 24B and 24C show a carrier arrangement 192A having two sheets (not designated) separated by a fold 70D. Carrier sheet arrangement 192A includes fastening layers 64G, 64H, 64I and 64J located on respective sides of both sheets. FIGS. 25A, 25B and 25C show a carrier arrangement 192B having two sheets (not designated) separated by a fold 70E. Carrier sheet arrangement 192B includes fastening layers 64K on the inner side of one sheet and layers 64L and 64M on both sides of the other sheet. Continuing, FIGS. 26A, 26B and 26C show a carrier sheet arrangement 192C having a fastening layer 64A and 64B on both sides of one sheet and a layer 64C on the outer side of another sheet. FIGS. 27A, 27B and 27C show a carrier sheet arrangement 192D having fastening layers 64D and 64E located on the outer side of both sheets. Finally, a carrier sheet arrangement 192E is shown in FIGS. 28A, 28B and 28C where only a single fastening layer 64F is used, with the fastening layer being disposed on the outer side of one of the sheets.

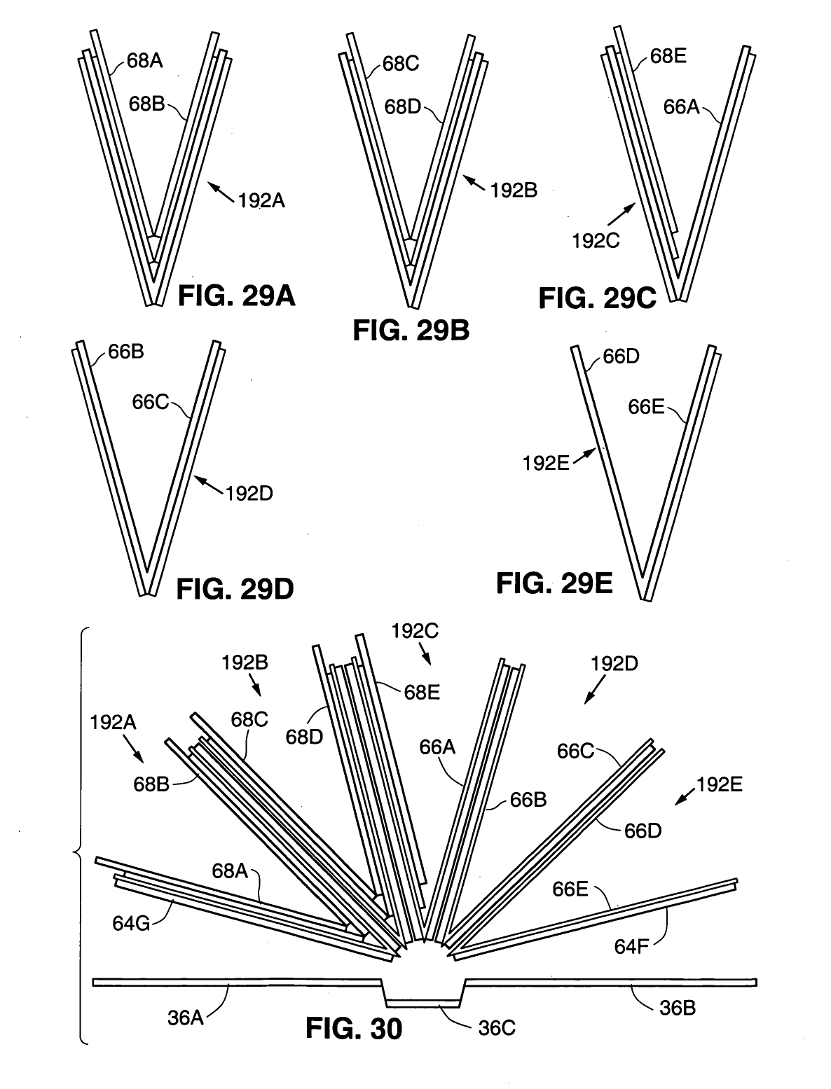

FIGS. 29A, 29B, 29C, 29D and 29E illustrate one example for using the five previously described carrier assemblies 192A/B/C/D/E. Photographs 68A and 68B are shown positioned on the inner fastening layers of assembly 192A, photographs 68C and 68D are shown positioned on the inner fastening layers of assembly 192B, photograph 68E is shown positioned on the one inner fastening layer of assembly 192C, with assemblies 192D and 192E having no photographs. The loaded carrier assemblies of FIGS. 29A-29E are positioned relative to one another as shown. The carrier assembly arrangement is then positioned within a hardcover assembly as shown in FIG. 30, with this assembly having no adhesive on the inner surfaces of the front and back cover sections 36A and 36B. The loaded carrier assembly and hardcover assembly are then positioned in a press and compressed thereby activating the various fastening layers. Thus, layer 64G will secure the assembly to the inner surface of the front cover section 36A and fastening layer 64F will secure the assembly to the inner surface of the back cover section 36B. The fastening layers intermediate the five carrier assemblies 192A-192F function to secure the assemblies together, with the fastening layers located adjacent the photographs functioning to secure the photographs to the carrier assembly. The bound album of FIG. 30 is intended to illustrate one application for the five carrier assemblies, with the particular arrangement shown not being that useful for an actual photo-album. Whatever combination or order is used, it is important that at least one fastening layer be located between adjacent ones of the carrier assemblies to that the adjacent assemblies will be secured together when the layers are activated by application of pressure. Also, it is sometimes preferable to connect adjacent carrier assemblies using only a single fastening layer. For example, sheets 66A and 66B of carrier assemblies 192C and 192D are shown connected together by redundant fastening layers whereas sheets 66C and 66D of assemblies 192D and 192E are connected to by only a single fastening layer. Thus, the page formed by sheets 66C and 66D may, depending upon the manner in which the fastening layers are implemented, provide an thinner and perhaps more attractive page than do sheets 66A and 66B. Carrier assembly 192E, having only one fastening layer, can be used where appropriate to eliminate redundant fastening layers.

Carrier assembly 192A is one of the most useful of the assemblies since one or more can function to display two, four, six or more photographs as desired. When assembly 192C is added, an attractive album having an odd number of photographs can be created and to allow a photograph to be displayed opposite a blank page. One or two assemblies 192C can also be used where it is desired that all photographs be located on album pages rather than being secured directly to the front or rear cover section. For example, assembly 192A is shown in FIG. 30 attaching photograph 68A directly to the inner surface of front cover section 36A. Assembly 192C could be used instead of assembly 192A so that carrier sheet 66A (FIG. 29C), which does not support a photograph, is secured to the front cover section 36A. In that event, assembly 192A or 192B could be used to support additional photographs. Assembly 192C can also being used in connection with the back cover section 36B if a photograph is not to be secured to the inner surface of that section.

Although FIG. 30 shows a hardcover assembly which relies upon the fastening layers 64G and 64G of the carrier assembly for securing the assembly to the hardcover, it would also be possible to utilize a conventional hardcover assembly such as described in connection with FIG. 20 which uses pressure sensitive adhesive layers covered by release liners together with end leaves 176A and 176B. In that event, assembly 192E could be used to replace one or both of these end leaves.

The characteristics of the fastening layers disclosed herein also enable the assembler to produce a proof of the album. The loaded carrier assembly 76 and end sheets if appropriate and hardcover assembly if appropriate, are placed in press 78A/78B, with the press applying a substantially reduced force of only a few pounds per square inch. The components of the loaded carrier assembly are weakly secured together so that the assembly can be fully examined without upsetting the assembly. If adjustments need to be made, the assembly can be adjusted, including repositioning of one or more photographs without damaging the photographs. Once the proof is satisfactory, the assembly can then be returned to the press for a normal compression cycle of typically 50 to 100 pounds per square inch as previously described.

It should also be noted that those fastening layers 64 where the support structure is implemented using part of the underlying carrier sheet 66 are somewhat more restricted in their application as compared to those fastening layers where the support structure is separate from the carrier sheet. By way of example, the FIG. 6A loaded carrier assembly 76 includes a carrier sheet 66B having a fastening layer 64D on one side and another fastening layer 64C located on the other side. If, for example, the fastening layer embodiment 82 of FIGS. 10A, 10B and 10C were utilized in this application, it can be seen that care must be taken in locating the hinged flap members 88 in the common carrier sheet 64 (or 64B of FIG. 6C) so that one group of flap members functions to provide the support structure function for fastening layer 64C and another group of flap members function to provide support structure for fastening layer 64D. Clearly, the same region of the carrier sheet for providing a flap member for layer 64C cannot be used to provide a flap member for layer 64D. In order to avoid this potential problem, it may be preferable to avoid using this embodiment of fastening layer for layer 64D (and 64E) and other similarly situated fastening layers by manufacturing the carrier assembly with the back sides of carrier sheets 66B and 66C adhered together using a conventional adhesive. This manufacturing option was previously described. In that case, fastening layer 64D is not needed so that fastening layer 64C can be implemented using embodiment 82 or embodiments 96 (FIGS. 11A, 11B and 11C) or embodiment 108 (FIGS. 12A, 12B and 12C). This issue is not present for those fastening layer embodiments that utilize a support structure independent of the underlying carrier sheet such as embodiment 118 (FIGS. 13A, 13B, 13C and 13D), embodiment 126 (FIGS. 14A, 14B and 14C) and embodiment 134 (FIGS. 15A, 15B and 15C).

As previously described, the fastening layers 64 (FIG. 5B) could also be implemented using heat activated adhesives rather than being based upon pressure sensitive adhesive. A heat activated adhesive marketed by National Starch and Chemical under the name Cool Bind 1300 has been found satisfactory for this application. The carrier assembly of FIG. 5B is loaded with photographs 68 in the same manner as previously described in connection with FIG. 7. Once the photographs have been loaded, the loaded carrier assembly 76 is positioned in a heated press as shown in FIG. 17A. This is done without the hardcover assembly. The press is closed over the assembly 76 as shown in FIG. 17B, with both the top and bottom plates 146A and 146B being provided with heating elements. The press is closed on the assembly so as to provide both heat and pressure. A pressure of approximately 5 pounds per square inch has been found to be suitable. A temperature sensor could be positioned in the center of the assembly 76 so that it can be determined when the interior of the assembly 76 has reached the desired temperature to ensure that the heat activated adhesive fastening layers have all been activated. The maximum temperature of the heating elements is limited so as to not damage the photographs being bound. A maximum temperature of approximately 200 degrees Fahrenheit has been found suitable for most applications. Pressure continues to be applied once the heating elements have been turned off to ensure a strong and uniform bond is made between all of the photographs and the underlying carrier sheets as the assembly cools. The press is provided with an array of cooling fans 148 located on both the upper and lower plates of the press to shorten the cooling time. Once the assembly has cooled, a hardcover can then be applied in the conventional manner as previously described.

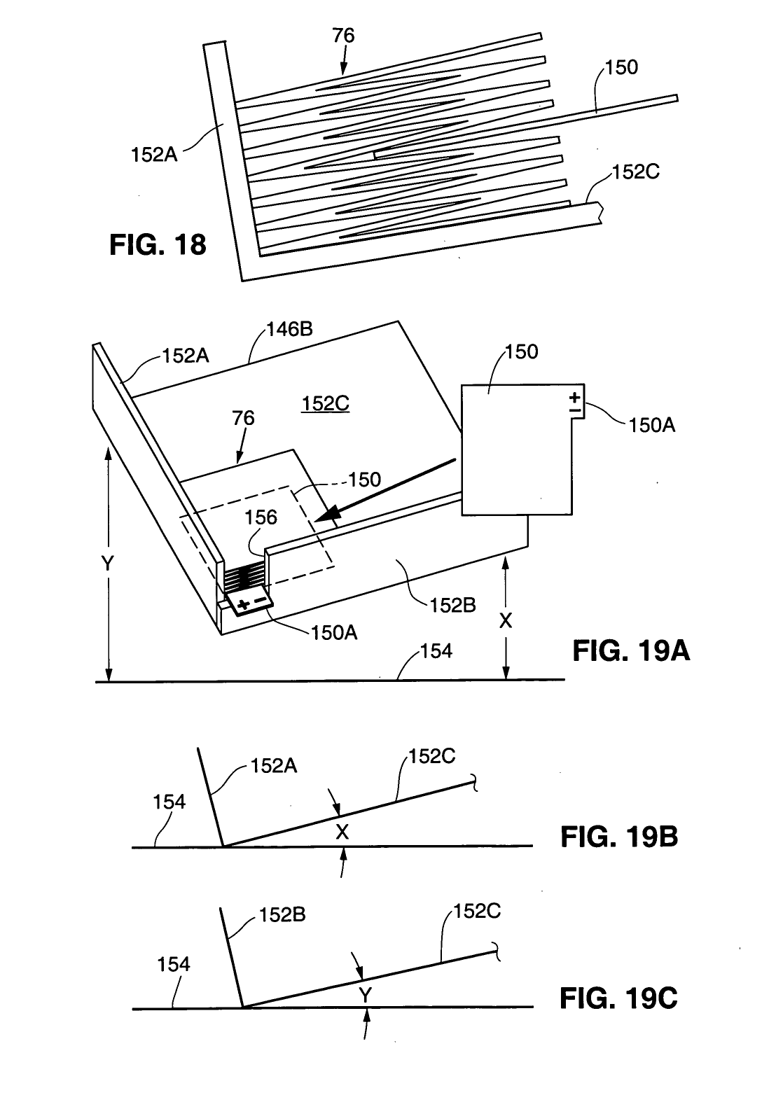

It is desirable to heat and cool the loaded carrier assembly quickly to as to shorten the assembly cycle time. As previously noted, cooling is facilitated by way of various cooling fans 148. It is also possible to shorten the heating time by adding one or more thin heating elements 150 as shown in FIGS. 18 and 19 that are inserted in the center (if only one is used) or in equally spaced locations if multiple heating elements are used, of the assembly 76. The thin heating elements 150, which can be implemented using conventional printed circuit board technology, are capable of withstanding the compression forces applied by the heating press. Heating elements utilizing etched foil technology manufactured by Minco have been found suitable for this application. Heating element 150 is preferably implemented to produce about 5.5 watts of power per square inch.

Preferably the bottom plate 146B, represented schematically in FIGS. 17A and 17B, includes an angled support surface 152C upon which the loaded carrier assembly 76 is positioned. Sidewalls 152A and 152B, which are perpendicular to one another, function to locate the assembly 76 on the bottom plate. Support surface 152C is preferably inclined downward with respect to a level plane represented by line 154 towards a sidewall 152B so that the assembly naturally rests against the sidewall. Surface 152C further is also preferably inclined downward so that assembly 76 rests against that sidewall. Line 154 represents a level plane, with the surface 152C being tilted with respect to the level plane 154 by an angle X (FIG. 19B) so that the assembly will tend to rest against sidewall 152A due to gravity. Similarly surface 152C is tilted down by an angle Y (FIG. 19C) with respect to the level plane so that the assembly will also tend to rest against sidewall 152B. Angles X and Y are both at least 5 degrees, with angle X preferably being approximately 20 degrees and angle Y preferably being approximately 30 degrees. Sidewalls 152A and 152B are perpendicular to one another, with angle X being measured along a line normal to sidewall 152A and with angle Y being measured along a line normal to sidewall 152B. Note that the upper plate 146A moves in an angled direction normal to surface 152C, with the compressing surface of the upper plate being parallel to the tilted lower compressing surface 152C. A cutout 156 is formed in sidewall 152B to accommodate the heater contact 150A or contacts if multiple heaters are used. An electrical cable (not depicted) is connected to connector 150A to provide power to the heater. It should be noted that the press for the pressure activated adhesive based fastening layers of FIGS. 8A and 8B could also employ a lower plate utilizing an angled support surface as described in connection with FIGS. 19A,B and C so that the assembly will be registered against sidewalls 152A and 152B by the force of gravity. Again, the upper plate 78A would move in a direction normal to the tilted support surface of the lower plate with the upper plate compressing surface remaining parallel to the tilted lower plate surface.

Although various embodiments of the present invention have been described in some detail, it is to be understood that various changes could be made by those skilled in the art without departing from the spirit and scope of the present invention as recited in the appended claims.

1. A bound book comprising:
first and second display sheets, each having similar dimensions;
a carrier sheet arrangement folded at least once to provide first and second carrier sheets and a first fold intermediate the first and second carrier sheets, with the first and second carrier sheets each having dimensions that generally correspond to the dimensions of the first and second display sheets;
a first fastening layer disposed intermediate the first carrier sheet and the first display sheet, with said first fastening layer securing the first display sheet to the first carrier sheet so that a first edge of the first display sheet is disposed adjacent the first fold;
a second fastening layer disposed intermediate the second carrier sheet and the second display sheet, with the second fastening layer securing the second display sheet to the second carrier sheet so that a first edge of the second display sheet is disposed adjacent the first fold;
a cover assembly including first and second covers, with the cover assembly being secured to the carrier sheet arrangement so that the first and second display sheets are disposed intermediate the first and second covers and the first and second display sheets contact one another when the cover assembly is in a closed position.

2. The bound book of claim 1 further including:
third and fourth display sheets, each having dimensions similar to the first and second display sheets;
wherein the carrier sheet arrangement is folded at least two additional times to provide second and third folds, with the second fold being disposed intermediate the second carrier sheet and a third carrier sheet and with the third fold being disposed intermediate the third carrier sheet and a fourth carrier sheet, with the third and fourth carrier sheets each having dimensions that generally correspond to the dimensions of the third and fourth display sheets;
a third fastening layer disposed intermediate the third carrier sheet and the third display sheet, with said third fastening layer securing the third display sheet to the third carrier sheet so that a first edge of the third display sheet is disposed adjacent the third fold;
a fourth fastening layer disposed intermediate the fourth carrier sheet and the fourth display sheet, with the fourth fastening layer securing the fourth display sheet to the fourth carrier sheet so that a first edge of the fourth display sheet is disposed adjacent the first fold; and
wherein the cover assembly is secured to the carrier sheet arrangement so that the first, second, third and fourth display sheets are disposed intermediate the first and second covers, the first and second display sheets contact one another and the third and fourth display sheet contact one another when the cover assembly is in a closed position.

3. The bound book of claim 2 further including a fifth fastening layer intermediate the second and third carrier sheets so as to secure the third and fourth carrier sheets together.

4. The bound book of claim 3 wherein the first, second, third and fourth fastening layers each include heat sensitive adhesive.

5. The bound book of claim 3 wherein the first, second, third and fourth fastening layers each include pressure sensitive adhesive.

6. The bound book of claim 5 wherein the first, second, third and fourth fastening layers each have a tackiness characteristic which increases with an increase in applied pressure.

7. The bound book of claim 6 wherein the first, second, third and fourth fastening layers each include a mixture of pressure sensitive adhesive and granulated material.

8. The bound book of claim 7 wherein the granulated material includes sand.

9. The bound book of claim 6 wherein the first, second, third and fourth fastening layers each include a layer of the pressure sensitive adhesive and a porous layer which includes porous material, with porous later permitting passage of some of the pressure sensitive adhesive upon application of pressure.

10. The bound book of claim 9 wherein the porous material includes non- woven fabric.

11. The bound book of claim 1 wherein the first and second display sheets include respective first and second photographs.

12. A binding structure for use in binding a plurality of display sheets, said structure comprising:
a carrier sheet arrangement folded at least five times to provide at least six carrier sheets, with each of the carrier sheets having dimensions that generally correspond to dimensions of the display sheets, with a first fold being disposed intermediate first and second carrier sheets, with a second fold being disposed intermediate second and third carrier sheets, with the third fold being disposed intermediate third and fourth carrier sheets, with a fourth fold being disposed intermediate fourth and fifth carrier sheets and with a fifth fold disposed intermediate fifth and sixth carrier sheets, with the carrier sheet arrangement being movable between an expanded and compressed position; and
first, second, third, fourth, fifth and sixth fastening layers disposed on respective ones of the first, second, third, fourth, fifth and sixth carrier sheets such that first and second fastening layers, the third and fourth fastening layers and the fifth and sixth fastening layers contact each other when the carrier sheet is moved to the compressed position, with each of the fastening layers including pressure sensitive adhesive and with each of the fastening layers having a tackiness characteristic which increases with an increase in applied pressure.

13. The binding structure of claim 12 further including adhesive which secures the second and third carrier sheets together so that first and third folds are positioned adjacent one another and secures the fourth and fifth carrier sheets together so that the third and fifth folds are positioned adjacent one another when the carrier sheet is moved to the expanded position.

14. The binding structure of claim 12 wherein each of the fastening layers includes a mixture of the pressure sensitive adhesive and granulated material.

15. The binding structure of claim 14 wherein the granulated material includes sand.

16. The binding structure of claim 12 wherein the pressure sensitive adhesive is supported on the carrier sheet on which the fastening layer is disposed at a first surface of the pressure sensitive adhesive and wherein the fastening layer further includes a support structure extending past a second surface of the pressure sensitive adhesive, opposite the first surface, so that pressure applied to the fastening layer in a direction towards the carrier sheet will displace the support structure so that at least a portion of the pressure sensitive adhesive extends past the support structure thereby exposing the portion of the pressure sensitive adhesive for contacting a display sheet.

17. The binding structure of claim 16 the support structure includes an array of separate and spaced apart support members.

18. The binding structure of claim 17 wherein the array includes at least one of the separate support members for each square inch of carrier sheet area.

19. The binding structure of claim 17 wherein the support members are separate from the carrier sheets.

20. The binding structure of claim 19 wherein the pressure sensitive adhesive includes separated regions of pressure sensitive adhesive, with one of the separated regions of pressure sensitive adhesive being associated with each of the separate support members.

21. The binding structure of claim 17 wherein the separate support members are each connected to the carrier sheet.

22. The binding structure of claim 21 wherein the separate support members are each formed from the carrier sheet.

23. The binding structure of claim 22 wherein the separate support members are each formed by cutting the carrier sheet to form a flap member, a portion of which remains connected to the carrier sheet to from a hinge section, with the flap member movable about the hinge section to a first position so that a part of the flap member extends away from the carrier sheet past the second surface of the pressure sensitive layer and to a second position towards the carrier sheet.

24. The binding structure of claim 16 where the carrier sheets each include a multiplicity of deformations which define a carrier sheet first surface which supports the first surface of the pressure sensitive adhesive layer and a carrier sheet second surface, with that portion carrier sheet extending from the first to the second surface of the carrier sheet forming at least part of the support structure of the fastening layers.

25. The binding structure of claim 24 wherein the carrier sheet second surface extends past the second surface of the pressure sensitive adhesive and wherein the multiplicity of deformations includes a multiplicity of spaced apart wells formed in the carrier sheets, with a section of the pressure sensitive adhesive disposed within each of the wells on the first surface of the carrier sheet, with regions of the carrier sheet intermediate the wells forming the second surface of the carrier sheet, with regions of the carrier sheet extending from the first to the second surfaces of the carrier sheet together with the regions of the carrier sheet intermediate the wells forming the support structure.

26. The binding structure of claim 25 wherein the wells are arranged in an array, with the array including at least one well for each square inch of carrier sheet area.

27. The binding structure of claim 22 wherein the deformations in the carrier sheet include separate raised areas extending from the first surface of the carrier sheet to the second surface of the carrier sheet, with the first surface of the carrier sheet supporting the first surface of the adhesive layer.

28. The binding structure of claim 27 wherein the separate raised areas are disposed in an array, with the array including at least one raised area for each square inch of carrier sheet area.

29. The binding structure of claim 28 wherein the pressure sensitive adhesive extends around at least some of the separate raised areas.

30. The binding structure of claim 28 wherein the support structure further includes a separate support member disposed on the raised areas, with the support members being separate from the carrier sheets and having a surface which extends past the second surface of the pressure sensitive adhesive.

31. A method of binding a multiplicity of display sheets comprising:
providing a carrier sheet arrangement folded at least three times to produce at least first, second, third and fourth carrier sheets, with carrier sheets having dimensions that generally correspond to dimensions of the display sheets and with the first fold being disposed intermediate the first and second carrier sheets, with the second fold being disposed intermediate the second and third carrier sheet and with the third fold being disposed intermediate the third and fourth carrier sheet;
positioning first, second, third and fourth ones of the multiplicity of display sheets over the respective first, second, third and fourth carrier sheets; and
after the positioning, securing the first, second, third and fourth display sheets to the respective first, second, third and fourth carrier sheets using adhesive.

32. The method of claim 31 wherein the display sheets include photographs.

33. The method of claim 31 wherein the carrier sheet arrangement is movable between an expanded position and a compressed position, wherein the positioning takes place while the carrier sheet arrangement is in the expanded position and wherein the securing takes place when the carrier sheet arrangement is in the compressed position.

34. The method of claim 33 wherein the adhesive is a heat activated adhesive and wherein the securing includes applying heat while the carrier sheet arrangement is in the compressed position.

35. The method of claim 34 further including positioning at least one heating elements intermediate two of the carrier sheets when the carrier sheet arrangement is in the expanded position and wherein the securing includes activating the at least one heating element when the carrier sheet arrangement is in the compressed position.

36. The method of claim 33 wherein the adhesive is a pressure activated adhesive.

37. The method of claim 36 wherein the providing a carrier sheet arrangement includes first, second, third and fourth fastening layers disposed on the respective first, second, third and fourth carrier sheets, with the fastening layers each including the pressure activated adhesive.

38. The method of claim 37 wherein the fastening layers each include a layer of pressure sensitive adhesive having a first surface disposed on the associated carrier sheet and a support structure disposed at least at a second surface of the pressure sensitive adhesive layer and wherein the positioning of the display sheets includes positioning the respective display sheets on the respective fastening layers so that the display sheets contact the respective support structures.

39. The method of claim 38 wherein the securing includes applying force to the carrier sheet arrangement when the carrier sheet arrangement is in the compressed position, with the force being sufficient to displace at least part of the respective support structures so that the pressure sensitive adhesive contacts the respective display sheets.

40. The method of claim 39 wherein the support structures each include granulated material which is forced into the pressure sensitive adhesive layer when the force is applied.

41. The method of claim 40 wherein the granulated material includes sand.

42. The method of claim 39 wherein support structure includes a portion of the associated carrier sheet which extends through at least part of the layer of pressure sensitive adhesive.

43. The method of claim 42 wherein the support structure includes a plurality of raised portions of the carrier sheet and wherein the layer of pressure adhesive is a non-uniform layer which extends around the raised portions of carrier sheet.

44. A carrier sheet arrangement comprising:
a carrier sheet having first and second opposite surfaces;
a first fastening layer disposed on the first surface of the carrier sheet and including a layer of pressure sensitive adhesive having a first adhesive surface disposed on the first surface of the carrier sheet and a second adhesive surface and a support structure disposed at least at the second adhesive surface, with said support structure being capable of being displaced upon application of pressure so that at least a portion of the pressure sensitive extends past the support structure so that the portion is available for securing an object to the carrier sheet; and
a second fastening layer disposed on the second surface of the carrier sheet and including a layer of pressure sensitive adhesive having a first adhesive surface disposed on the second surface of the carrier sheet and a second adhesive surface and a support structure disposed at least at the second adhesive surface, with said support structure being capable of being displaced unon application of pressure so that at least a portion of the pressure sensitive extends past the support structure so that the portion is available for securing an object to the carrier sheet.

45. The carrier sheet arrangement of claim 44 wherein the support structures each include granulated material.

46. The carrier sheet arrangement of claim 45 where the granulated material includes sand.

47. The carrier sheet arrangement of claim 44 wherein the support structures each include non-woven fabric.

48. The carrier sheet arrangement of claim 44 wherein the support structures are each connected to the carrier sheet and extend towards the second surface of the pressure sensitive adhesive layer of the associated fastening layer.

49-60. (canceled)
